(19) United States
(12) Patent Application Publication
(10) Pub. No.: US 2026/0268301 A1
(43) Pub. Date: Sep. 10, 2026

(54) PAYMENT SYSTEM, PAYMENT METHOD, AND RECORDING MEDIUM

(71) Applicant: NEC Corporation, Minato-ku, Tokyo (JP)

(72) Inventors: Rumi IKEZAWA, Tokyo (JP); Tadamasa Yokoyama, Tokyo (JP)

(73) Assignee: NEC Corporation, Minato-ku, Tokyo (JP)

(21) Appl. No.: 18/714,229

(22) PCT Filed: Dec. 22, 2021
(86) PCT No.: PCT/JP2021/047470

§ 371 Date: May 29, 2024

(51) Int. Cl. G06Q 20/22

(52) U.S. Cl. CPC G06Q 20/227

(57) ABSTRACT

A payment system comprising an identification information acquisition unit, a first reception unit, and a second reception unit. The identification information acquisition unit acquires identification information of a product that a customer intends to purchased by the customer performing an operation on a terminal device. The first reception unit receives, from the terminal device, an instruction of payment of a first amount of money from the purchase price of the products registered by means of the identification information. The second reception unit receives, in a payment device, an instruction of payment of a second amount equal to the difference between the purchase price and the first amount.

### TECHNICAL FIELD

The present disclosure relates to a payment system and the like.

### BACKGROUND ART

There is scan shopping for registering a product on a terminal device by an operation by a customer.

For example, there is a technique of transmitting information about an electronic coupon to an accounting machine when a customer desires to use the electronic coupon in a personal portable terminal (see, for example, PTL 1).

In the store, there are various payment methods such as a credit payment, a code payment, a payment by cash voucher, and a point payment.

### CITATION LIST

### Patent Literature

PTL 1: JP 2014-038539 A

### SUMMARY OF INVENTION

### Technical Problem

A customer may want to use various payment methods when purchasing a product. In a case where a product is registered by a customer's operation on a terminal device, it may be inconvenient that a plurality of payments cannot be made.

An object of the present disclosure is to provide a payment system and the like capable of improving convenience of payment in a case where a product is registered by an operation by a customer on a terminal device.

### Solution to Problem

A payment system according to an aspect of the present disclosure includes an identification information acquisition means configured to acquire identification information about a product planned to be purchased by a customer by an operation by the customer on a terminal device, a first reception means configured to receive, from the terminal device, an instruction of a payment of a first amount of money in a purchase amount of money of the product registered based on the acquired identification information, and a second reception means, of the adjustment device, configured to receive an instruction of a payment of a second amount of money that is a difference between the purchase amount of money and the first amount of money.

A payment method according to an aspect of the present disclosure is a payment method of a payment system including an information processing device and an adjustment device, the payment method including the information processing device acquiring identification information about a product planned to be purchased by a customer by an operation by the customer on a terminal device, and receiving, from the terminal device, an instruction of a payment of a first amount of money in a purchase amount of money of the product registered based on the acquired identification information, and the adjustment device receiving an instruction of a payment of a second amount of money that is a difference between the purchase amount of money and the first amount of money.

A program according to an aspect of the present disclosure is a program of a payment system including an information processing device and an adjustment device, the program causing a computer of the information processing device to execute the steps of acquiring identification information about a product planned to be purchased by a customer by an operation by the customer on a terminal device, and receiving, from the terminal device, an instruction of a payment of a first amount of money in a purchase amount of money of the product registered based on the acquired identification information, and a computer of the adjustment device to execute the step of receiving an instruction of a payment of a second amount of money that is a difference between the purchase amount of money and the first amount of money.

Each program may be stored in a non-transitory computer-readable recording medium.

### Advantageous Effects of Invention

According to the present disclosure, it is possible to improve convenience of payment in a case where a product is registered by an operation by a customer on a terminal device.

### BRIEF DESCRIPTION OF DRAWINGS

FIG. 1 is a block diagram illustrating a configuration example of a payment system according to the first example embodiment.

FIG. 2 is a flowchart illustrating an operation example of the payment system according to the first example embodiment.

FIG. 3 is an explanatory diagram illustrating a connection example of each device according to the second example embodiment.

FIG. 4 is a block diagram illustrating a configuration example of an information processing device.

FIG. 5 is a block diagram illustrating a configuration example of a terminal device.

FIG. 6 is a block diagram illustrating a configuration example of an adjustment device.

FIG. 7 is an explanatory diagram illustrating an example of reading a product code.

FIG. 8 is an explanatory diagram illustrating a display example of a list.

FIG. 9 is an explanatory diagram illustrating an example of an input of an amount of money that the credit payment is to be made of.

FIG. 10 is an explanatory diagram illustrating an input example of payment information.

FIG. 11 is an explanatory diagram illustrating an example of details of a credit payment.

FIG. 12 is an explanatory diagram illustrating a display example of identification information about an adjustment device that makes a payment of a second amount of money.

FIG. 13 is an explanatory diagram illustrating a display example of a code.

FIG. 14 is an explanatory diagram illustrating an input example of an amount of a paper cash voucher.

FIG. 15 is a flowchart illustrating an operation example of the information processing device.

FIG. 16 is a flowchart illustrating an example of a specific processing procedure of a product registration process (step S201) by the information processing device.

FIG. 17 is a flowchart (part 1) illustrating an example of a specific processing procedure of a payment process (step S202) by the information processing device.

FIG. 18 is a flowchart (part 2) illustrating an example of a specific processing procedure of a payment process (step S202) by the information processing device.

FIG. 19 is a flowchart illustrating an example of a specific processing procedure of a product registration process (step 301) by the terminal device.

FIG. 20 is a flowchart illustrating an example of a specific processing procedure of a payment process (step S302) by the terminal device.

FIG. 21 is a flowchart illustrating an operation example of the adjustment device.

FIG. 22 is an explanatory diagram illustrating a registration example of an amount of use of points.

FIG. 23 is an explanatory diagram illustrating an example of receiving identification information about an in-house gift certificate.

FIG. 24 is an explanatory diagram (part 1) illustrating another example of the list screen.

FIG. 25 is an explanatory diagram (part 2) illustrating another example of the list screen.

FIG. 26 is an explanatory diagram illustrating a selection example of a type of a gift certificate.

FIG. 27 is a flowchart illustrating an example of a specific processing procedure of a payment process (step S202) by the information processing device in a case where a first amount of money is discounted.

FIG. 28 is a flowchart illustrating an example of a specific processing procedure of a payment process (step S302) by the terminal device in a case where the first amount of money is discounted.

FIG. 29 is a block diagram illustrating another configuration example of the information processing device.

FIG. 30 is a flowchart illustrating another operation example of the information processing device.

FIG. 31 is a block diagram illustrating another configuration example of the adjustment device.

FIG. 32 is a flowchart illustrating another operation example of the adjustment device.

FIG. 33 is an explanatory diagram illustrating a hardware configuration example of a computer device.

### EXAMPLE EMBODIMENT

Hereinafter, example embodiments of a payment system, an information processing device, an adjustment device, a payment method, a program, and a non-transitory recording medium recording the program according to the present disclosure will be described in detail with reference to the drawings. The present example embodiment does not limit the disclosed technology. In the example embodiment, the amount of money is described in units of yen as an example.

### First Example Embodiment

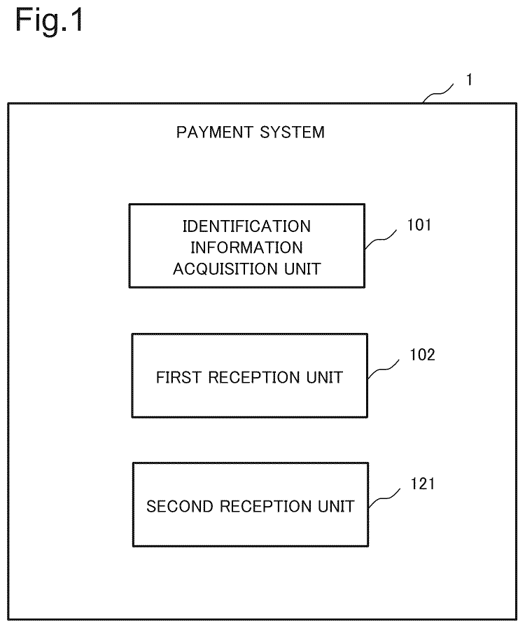

First, in the first example embodiment, a basic function of a payment system will be described. FIG. 1 is a block diagram illustrating a configuration example of a payment system according to the first example embodiment. A payment system 1 includes, for example, an identification information acquisition unit 101, a first reception unit 102, and a second reception unit 121.

The payment system 1 may include, for example, an information processing device and an adjustment device. In such a case, for example, the information processing device includes the identification information acquisition unit 101 and the first reception unit 102. The adjustment device includes the second reception unit 121.

Identification information acquisition unit 101 acquires the identification information about the product planned to be purchased by the customer by the operation by the customer on the terminal device. The product identification information is not particularly limited as long as the product can be uniquely identified. The product identification information is, for example, a product code, a product name, an image of a product, or the like. Examples of the product code include a Japanese Article Number (JAN) code, a European Article Number (EAN) code, and a Universal Product Code (UPC), but are not particularly limited thereto. The product code may be displayed on the product by being represented by, for example, a one-dimensional code (barcode) and a two-dimensional code. The product code may be displayed on the product in a numeric string together with at least one of the one-dimensional code and the two-dimensional code.

The terminal device is a device operable by a customer and is a device portable by the customer. For example, the terminal device may be a device of a customer or a device of a store lent to a customer in a store. The terminal device may be attached to a shopping cart or the like. The store may be, for example, a store such as a supermarket, a supermarket center, a convenience store, a mass merchandise store, a home center, a drug store, a store that handles apparel products, or an individual store such as a bakery or a daily dish store, and is not particularly limited.

The first reception unit 102 receives, from the terminal device by the operation by the customer, an instruction of a payment of the first amount of money in the purchase amount of money of the product registered by the acquired identification information. Specifically, for example, the first reception unit 102 regards receiving the input of the first amount of money by the operation by the customer as receiving an instruction of a payment of the first amount of money. The first reception unit 102 receiving the input of each amount of money means receiving at least one of the numerical value of the amount of money and the identification information indicating the amount of money. For example, receiving the identification information indicating the amount of money may be, for example, registration of various types of cash vouchers. The purchase amount of money is, for example, a total purchase amount of money. The first amount of money is a payment amount made via the terminal device. The second amount of money is an amount of payment made by the adjustment device. For example, the purchase amount of money is the total amount of the first amount of money and the second amount of money. Therefore, when the input of the first amount of money is received, the second amount of money is the difference between the total amount and the first amount of money. Alternatively, for example, the first reception unit 102 may receive the first amount of money that is the difference between the total amount and the second amount of money by receiving the input of the second amount of money by the operation by the customer on the terminal device. The timing at which the first reception unit 102 receives the amount of money may be after product registration or during product registration, and is not particularly limited.

The second reception unit 121, of an adjustment device, receives an instruction of a payment of a second amount of money that is the difference between the purchase amount of money and the first amount of money. For example, the second reception unit 121, of the adjustment device, receives an instruction of a payment of the second amount of money by an operation by the customer or the store clerk. More specifically, for example, the second reception unit 121 acquires adjustment information about the second amount of money or an identifier indicating the adjustment information from the terminal device. As a result, the second reception unit 121 may determine that an instruction of a payment has been received. Alternatively, in the adjustment device that has received the adjustment information related to the second amount of money from the information processing device, the second reception unit 121 may receive an instruction to start the payment by the operation by the customer. As a result, the second reception unit 121 may determine that an instruction of a payment has been received.

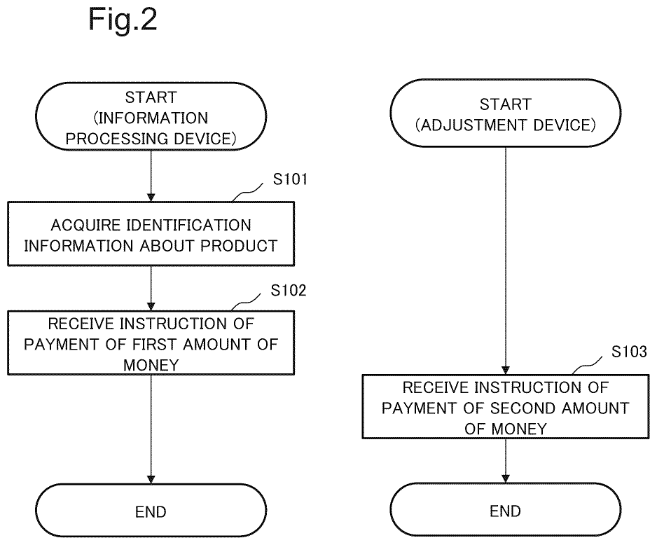

FIG. 2 is a flowchart illustrating an operation example of the payment system 1 according to the first example embodiment.

Identification information acquisition unit 101 acquires the product identification information by the operation by the customer on the terminal device (step S101). The first reception unit 102 receives an instruction of a payment of the first amount of money by the operation by the customer on the terminal device (step S102). Next, the second reception unit 121, of the adjustment device, receives an instruction of a payment of the second amount of money that is the difference between the purchase amount of money and the first amount of money (step S103).

As described above, in the first example embodiment, the payment system 1 acquires the identification information about the product to be registered by the operation by the customer on the terminal device. The payment system 1 receives, from the terminal device, an instruction of a payment of the first amount of money in the purchase amount of money of the product registered by the acquired identification information. Then, the payment system 1 receives an instruction of a payment of the second amount of money that is the difference between the purchase amount of money and the first amount of money in the adjustment device. As a result, in a case where the product is registered by the operation by the customer on the terminal device, a plurality of payments can be made, and convenience at the time of shopping can be improved.

The process that can be performed via the terminal device by the operation by the customer is ended in the terminal device, so that the process performed via the adjustment device can be reduced. As a result, congestion of the adjustment device can be suppressed. When the adjustment device operated by the store clerk is used, the labor of the store clerk can be saved.

The first example embodiment is not limited to the example described above, and various modifications can be made. Each function unit of the information processing device may be implemented by one device. Alternatively, each function unit of the information processing device may be implemented by a plurality of devices.

### Second Example Embodiment

Next, the second example embodiment will be described in detail with reference to the drawings. In the second example embodiment, a case where the first amount of money is paid through the terminal device and a case where the first amount of money is discounted through the terminal device will be described in detail. Hereinafter, description of content overlapping with the above description will be omitted to the extent that the description of the second example embodiment is not unclear.

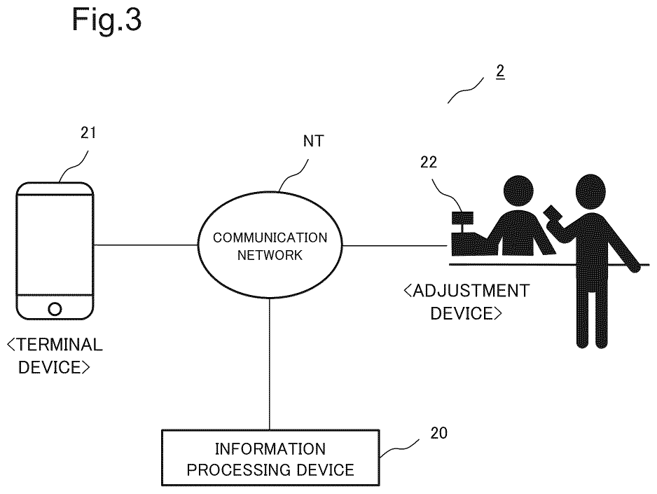

FIG. 3 is an explanatory diagram illustrating a connection example of each device according to the second example embodiment. For example, a payment system 2 includes an information processing device 20, a terminal device 21, and an adjustment device 22. For example, the information processing device 20 is connected to the terminal device 21 via a communication network NT. For example, the information processing device 20 is connected to the adjustment device 22 via the communication network NT.

As in the terminal device described in the first example embodiment, the terminal device 21 is a device operable by a customer and is a device portable by the customer. The type of the terminal device 21 is not particularly limited, and may be a smartphone, a tablet-type device, a device dedicated to a shop, or the like. For example, it is assumed that an application program for shopping in a store is installed in the terminal device 21 in advance. Then, the terminal device 21 exchanges various types of information with the information processing device 20 via the application program.

The information processing device 20 has a function of registering a product identified by identification information acquired by the terminal device 21 of the customer. The information processing device 20 has a function of generating adjustment information for making a payment. The information processing device 20 has a function of making at least one of a credit payment, an electronic money payment, and a code payment via the terminal device 21.

The adjustment device 22 has a function of making a payment. The adjustment device 22 may be a manned device in which a payment is made by an operation by a store clerk, or may be an unattended device in which a payment is made by an operation by a customer. The payment method performed by the adjustment device 22 is not particularly limited, such as a cash payment, a payment with various cash vouchers, a credit payment, an electronic money payment, and a code payment. For example, the adjustment device 22 may be a payment different from a payment made via the terminal device 21. This allows the customer to make various payments. When the payment made via the terminal device 21 is a credit payment and the payment made via the adjustment device 22 is a payment other than the credit payment, the customer can make various payments. Even with the same payment method, the customer can make various payments as long as the payment is provided by different companies. For example, when a code payment made via the terminal device 21 is different from a code payment made via the adjustment device 22, the customer can select various payments.

The payment made by the adjustment device 22 may be a payment that cannot be made via the terminal device 21. For example, permission may be required for a payment made via the terminal device 21. Therefore, the adjustment device 22 may make a payment that is not permitted to be made via the terminal device 21.

For example, the adjustment device 22 may make at least any one payment of a cash payment and a payment by a portable cash voucher. The portable cash voucher is used for payment instead of cash. Examples of the portable cash voucher include a paper cash voucher and a card cash voucher. The card cash voucher is, for example, a prepaid card. The paper cash voucher is also referred to as another store gift certificate. In the case of the another store gift certificate, when the amount of payment is less than the amount of the another store gift certificate, the change may be issued. However, a paper gift certificate issued independently by a company may be treated as a discount. This paper gift certificate is also referred to as an in-house gift certificate. On the other hand, in the case of the in-house gift certificate, when the amount of payment is less than the amount of the in-house gift certificate, the change may not be issued.

In the case of the another store gift certificate, a store clerk may collect the gift certificate. In this case, the adjustment device 22 is a manned device operated by the store clerk. In the case of the card cash voucher, the adjustment device 22 is a manned device if the operation by the store clerk is necessary. As described above, in a case where the adjustment device 22 makes at least one of the payment that requires the operation by the store clerk and the payment that requires the collection of the store clerk, the adjustment device 22 is a manned device.

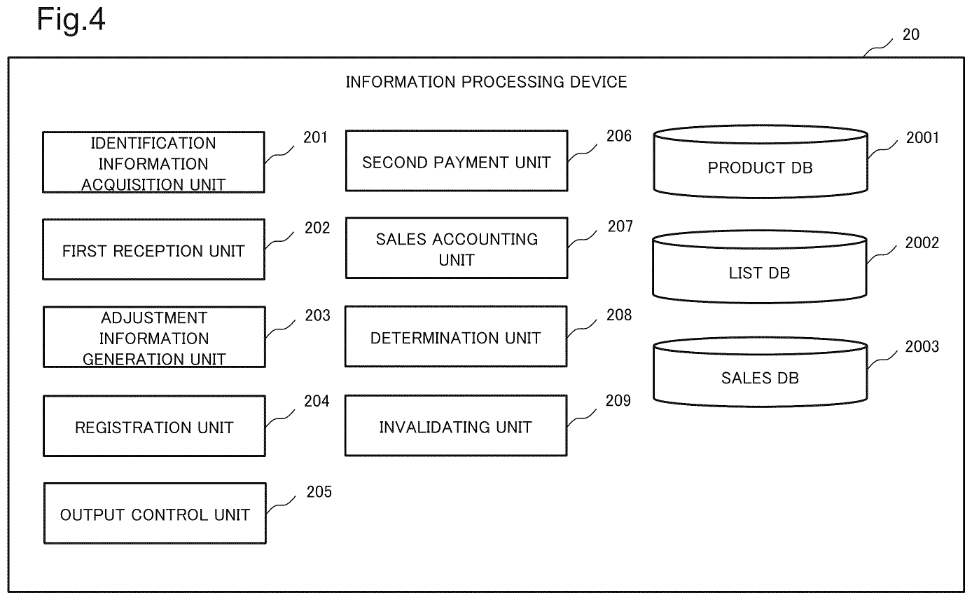

FIG. 4 is a block diagram illustrating a configuration example of the information processing device 20. The information processing device 20 includes an identification information acquisition unit 201, a first reception unit 202, an adjustment information generation unit 203, a registration unit 204, an output control unit 205, a second payment unit 206, a sales accounting unit 207, a determination unit 208, and an invalidating unit 209. The information processing device 20 includes the registration unit 204, the output control unit 205, the second payment unit 206, the sales accounting unit 207, the determination unit 208, and the invalidating unit 209 that are added to the units of the first example embodiment. Identification information acquisition unit 201 includes identification information acquisition unit 101 according to the first example embodiment as a basic function. The first reception unit 202 includes the first reception unit 102 according to the first example embodiment as a basic function. The adjustment information generation unit 203 includes the adjustment information generation unit 103 according to the first example embodiment as a basic function.

The product database (DB) 2001 stores product identification information and product information for each product in association with each other. For example, in a case where the product identification information is a product code, the information about the product is information such as a name of the product and a price of the product. The product information is not particularly limited.

The list DB 2002 stores, for each customer, the latest list on which payment has not been completed. In the list, for example, customer identification information for identifying a customer, product identification information (for example, the product code) of a product to be purchased by the customer, and information about a purchase quantity are stored in association with each other for each customer. The information for identifying the customer is not particularly limited as long as the information can uniquely identify the customer, for example. For example, before starting registration of a product to a new customer, a customer identifier (ID) is assigned to the customer as customer identification information. When the membership ID such as the point card number is received, the membership ID may be used as the customer ID. The list DB 2002 may store a list for each transaction. For example, when a list is stored for each transaction, a transaction ID may be assigned instead of the customer ID. The list may be referred to as a shopping basket.

The sales DB 2003 stores, for example, information about sales. For example, the sales DB 2003 may manage information related to each transaction. For example, the sales DB 2003 stores each piece of information about a customer ID or a transaction ID, identification information about a purchased product, a purchase quantity for each product, an amount of payment by each payment method, an amount of money of various types of discounts, identification information about the adjustment device 22 that has made a payment, and a purchase date and time in association with each other.

The output control unit 205 controls the output of the terminal device 21. For example, the output control unit 205 displays various types of information on the terminal device 21.

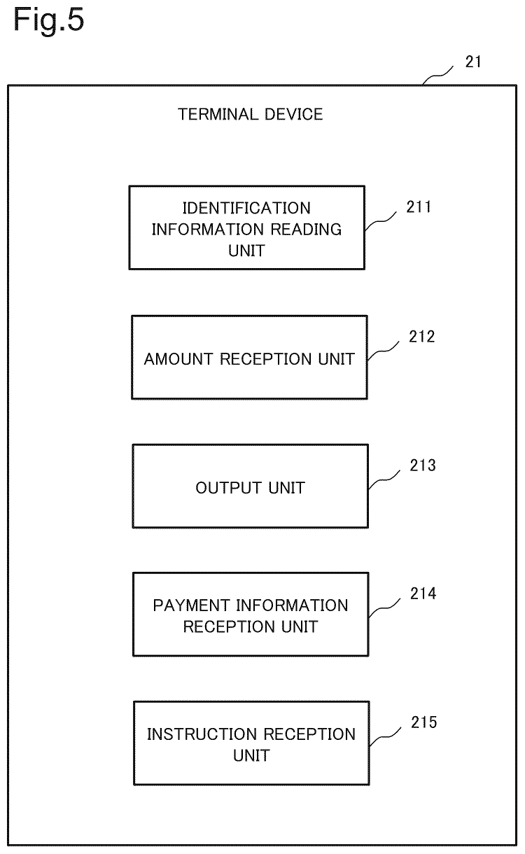

FIG. 5 is a block diagram illustrating a configuration example of the terminal device 21. The terminal device 21 includes an identification information reading unit 211, an amount reception unit 212, an output unit 213, a payment information reception unit 214, and an instruction reception unit 215.

The output unit 213 outputs to the output device of the terminal device 21. The output device is not particularly limited, and examples thereof include a display device such as a display and a light, and an audio output device such as a speaker. The display device may be an input/output device integrated with the input device, such as a touch panel display.

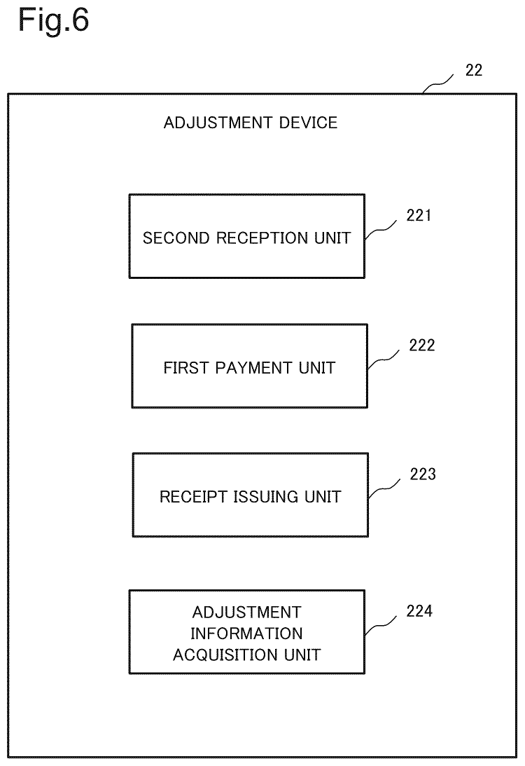

FIG. 6 is a block diagram illustrating a configuration example of the adjustment device 22. The adjustment device 22 includes a second reception unit 221, a first payment unit 222, a receipt issuing unit 223, and an adjustment information acquisition unit 224. The second reception unit 221 has the basic function of the second reception unit 121 according to the first example embodiment.

### <Registration of Product>

First, product registration will be described.

Identification information acquisition unit 201 acquires the identification information about the product to be purchased by the customer by the operation by the customer on terminal device 21.

Specifically, for example, the identification information reading unit 211 reads the identification information about the product to be purchased by the customer by the operation by the customer. Reading the product identification information means acquiring the product identification information. A reading method of the identification information reading unit 211 reading the identification information is not particularly limited. As described above, the identification information is not particularly limited as long as the customer can uniquely identify the product planned to be purchased. The identification information reading unit 211 transmits the read identification information to the information processing device 20. Then, the identification information acquisition unit 201 can acquire the identification information by receiving the identification information.

Then, the registration unit 204 registers the product indicated by the identification information. The registration unit 204 registering the product indicated by the identification information in the list means, for example, adding the identification information to the list.

Taking a product code as identification information as an example, an example in which a product code is read from a barcode displayed on a product will be described as an example of the identification information.

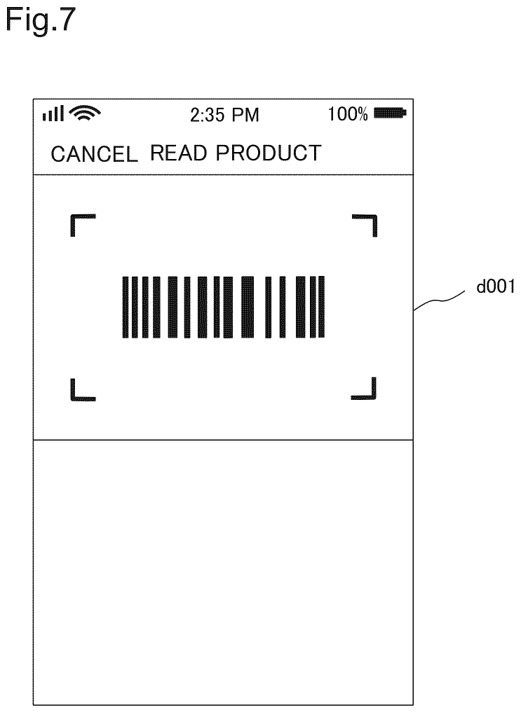

FIG. 7 is an explanatory diagram illustrating an example of reading a product code. For example, the output control unit 205 displays a reading screen d001 on the terminal device 21. The output unit 213 displays the reading screen d001 on the terminal device 21. In FIG. 7, an imaging device is activated in the terminal device 21. A reading frame is displayed on the reading screen d001. The reading frame indicates a position where the imaging device of the terminal device 21 can read the barcode. Hereinafter, the reading frame may be simply referred to as a frame. For example, when the barcode enters the frame of the reading screen d001, the identification information reading unit 211 recognizes the barcode from the image. Then, the identification information reading unit 211 transmits the product code indicated by the barcode to the information processing device 20. As a result, the product code is read, and the read product code is transmitted to the information processing device 20. The identification information reading unit 211 may transmit the product code together with the customer ID or the transaction ID.

The identification information acquisition unit 201 receives the product code. As a result, the identification information acquisition unit 201 can acquire the product code. Then, the registration unit 204 adds the product code from a list DB 2002 to the list identified by the customer ID or the transaction ID. Then, the output control unit 205 may displays, on the terminal device 21, a list in which new products are registered on the terminal device 21.

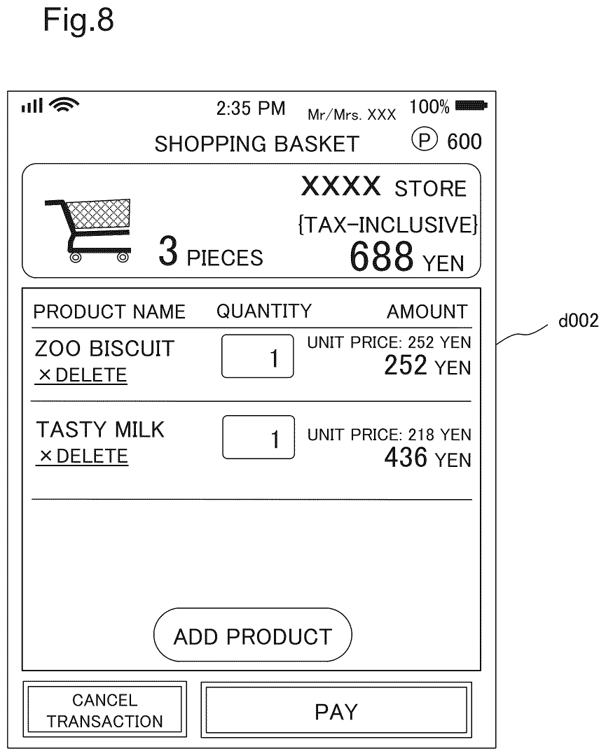

FIG. 8 is an explanatory diagram illustrating a display example of a list. The output unit 213 displays the list on the terminal device 21. A list screen d002 includes information such as the name, purchase quantity, and price of each product registered in the list, the total number of products, and the total purchase amount of money of the products. The list screen d002 includes, for example, an “ADD PRODUCT” button, a “PAY” button, a “CANCEL TRANSACTION” button, and the like. For example, when various buttons are tapped, the instruction reception unit 215 determines that an instruction related to the button has been received to transmit the instruction to the information processing device 20. The “ADD PRODUCT” button is a button for receiving a reading instruction. The reading instruction is an instruction to newly read product identification information. The “PAY” button is a button for receiving a payment instruction. The payment instruction is an instruction for completing product registration and making a payment. The “CANCEL TRANSACTION” button is a button for receiving a transaction cancel instruction. The cancel transaction instruction is an instruction to cancel the current transaction.

For example, when the “ADD PRODUCT” button is tapped, the instruction reception unit 215 transmits a reading instruction to the information processing device 20. As a result, the reading screen d001 illustrated in FIG. 7 is newly displayed on the terminal device 21, and the identification information reading unit 211 can read the product identification information.

For example, when the “PAY” button is tapped, the instruction reception unit 215 transmits a payment instruction to the information processing device 20. The instruction reception unit 215 may determine that the product registration is completed when receiving the payment instruction.

For example, when the “CANCEL TRANSACTION” button is tapped, the instruction reception unit 215 transmits a transaction cancel instruction to the information processing device 20. Accordingly, the transaction is terminated.

### <Payment>

Next, payment will be described. The first reception unit 202 receives an instruction of a payment of the first amount of money by receiving the first amount of money in the purchase amount of money by the operation by the customer on the terminal device. Receiving the amount of money by the first reception unit 202 means acquiring at least one of a numerical value of the amount of money and identification information indicating the amount of money. The timing at which the first reception unit 202 receives the first amount of money is not particularly limited, and may be after the product registration is completed, before the product registration is completed, or before the product registration starts.

Specifically, the first reception unit 202 receives the first amount of money via the amount reception unit 212 of the terminal device 21. For example, the amount reception unit 212 receives the first amount of money by the operation by the customer. Alternatively, the amount reception unit 212 may receive an amount obtained by subtracting the second amount of money from the purchase amount of money as the first amount of money by receiving the second amount of money that the adjustment device 22 makes a payment of in the purchase amount of money. Specific examples thereof will be described later with reference to the drawings. Then, the amount reception unit 212 transmits the first amount of money to the information processing device 20, so that the first reception unit 202 receives the first amount of money. The first reception unit 202 regards receiving the first amount of money as receiving an instruction of a payment of the first amount of money.

The adjustment information generation unit 203 generates adjustment information related to the second amount of money that the adjustment device 22 makes a payment of in the purchase amount of money. A case where the information processing device makes a payment of the first amount of money and a case where the information processing device 20 gives a discount of the first amount of money will be described separately.

### <Paying First Amount of Money>

First, an example in which the information processing device 20 pays the first amount of money will be described. The payment method of the information processing device 20 paying the first amount of money is a payment method capable of completing processing between the terminal device 21 and the information processing device 20. Examples of the payment method include a credit payment, an electronic money payment that can cooperate with an application program of a store, and a code payment that can cooperate with an application program of a store. The credit payment will be described as an example.

First, an example in which the amount reception unit 212 receives the input of the first amount of money will be described. An example in which the amount reception unit 212 receives an amount of money that the credit payment is to be made of as the first amount of money will be described.

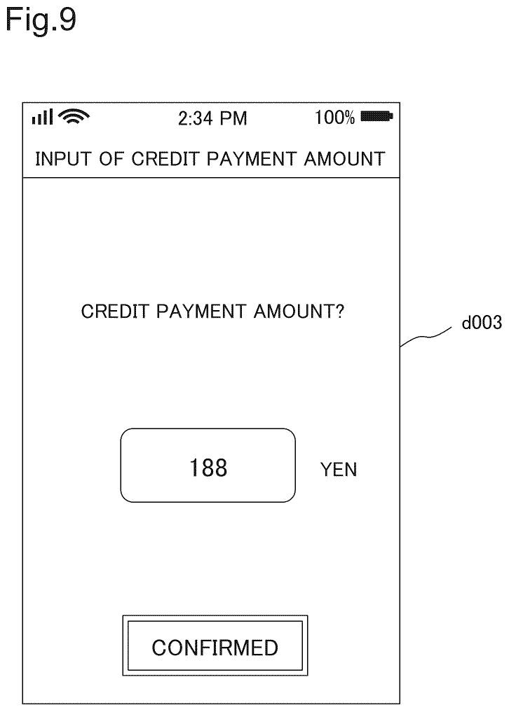

FIG. 9 is an explanatory diagram illustrating an input example of an amount of money that the credit payment is to be made of. The output control unit 205 may displays, on the terminal device 21, a screen d003 where the amount of the credit payment can be input. Then, output unit 213 displays the screen d003 on the display device of terminal device 21. The screen d003 has an input field in which the amount of credit payment can be input, and a “CONFIRMED” button. For example, when the “CONFIRMED” button is tapped, the amount reception unit 212 receives the amount of money input in the input field as the first amount of money. Then, the amount reception unit 212 transmits the first amount of money to the information processing device 20. The first reception unit 202 receives the first amount of money.

Next, the adjustment information generation unit 203 generates adjustment information for paying the first amount of money in the total purchase amount of money of the products included in the list. The total purchase amount of money is a tax-included purchase amount of money. The adjustment information includes, for example, information such as a first amount of money, a payee, and identification information about a store. This adjustment information is referred to as first adjustment information. The adjustment information generation unit 203 generates adjustment information for paying the second amount of money in the total purchase amount of money of the products included in the list. This adjustment information is referred to as second adjustment information.

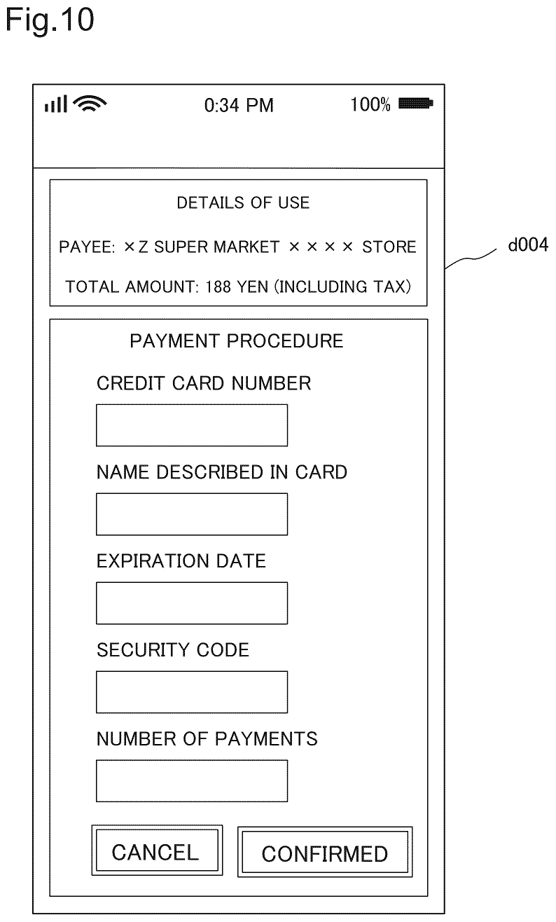

Then, the payment information reception unit 214 receives the adjustment information for making a credit payment of the first amount of money included in the first adjustment information. For example, the method of receiving the payment information may be registered in the terminal device 21 in advance, may be newly input by the customer, or may be selected from the payment information registered in the terminal device 21 by the operation by the customer, and is not particularly limited. An example of receiving input of payment information will be described with reference to FIG. 10.

FIG. 10 is an explanatory diagram illustrating an input example of payment information. The output control unit 205 displays, on the terminal device 21, a screen d004 where the payment information can be input. The output unit 213 displays, on the display device of the terminal device 21, the screen d004 where the payment information can be input. The screen d004 includes an input field in which payment information can be input, information such as a first amount of money, a payee, and a store name included in the first adjustment information, a “CONFIRMED” button, a “CANCEL” button, and the like. The “CANCEL” button may be, for example, a button for interrupting the credit payment and returning to the list screen, or a button for ending the transaction.

In FIG. 10, the payment information used for the credit payment is information such as a credit card number, a name written in a card, an expiration date, a security code, and the number of payments. When the “CONFIRMED” button is tapped, the payment information reception unit 214 receives the payment information input in each input field. Then, the payment information reception unit 214 transmits the payment information to the information processing device 20. Then, the second payment unit 206 makes a credit payment of the first amount of money based on the payment information.

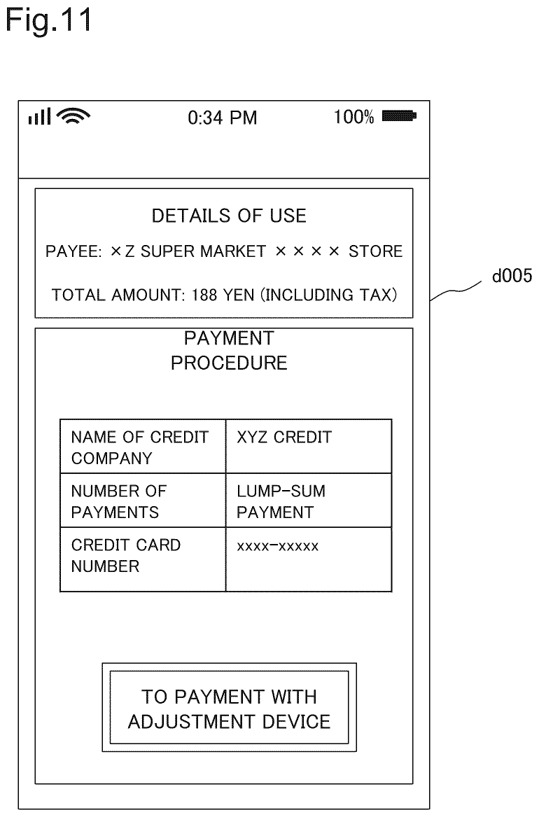

FIG. 11 is an explanatory diagram illustrating an example of details of a credit payment. For example, the output control unit 205 may displays, on the terminal device 21, the details of the credit payment after the credit payment is completed. The output unit 213 displays the details of the credit payment on the display device of the terminal device 21. For example, in FIG. 11, a screen d005 includes details of a credit payment and the “TO PAYMENT WITH ADJUSTMENT DEVICE” button. The payment with the adjustment device 22 is the payment of the second amount of money. When the “TO PAYMENT WITH ADJUSTMENT DEVICE” button is tapped, the terminal device 21 may transmit a payment request with the adjustment device 22 to the information processing device 20.

Next, for example, the second reception unit 221 of the adjustment device 22 receives an instruction of a payment of the second amount of money that is the difference between the purchase amount of money and the first amount of money. The second reception unit 221 may have a different method of receiving the payment instruction depending on the method of the adjustment information acquisition unit 224 acquiring the adjustment information related to the second amount of money. For example, the adjustment information acquisition unit 224 of the adjustment device 22 acquires second adjustment information related to the second amount of money. As a method of acquiring the second adjustment information, the adjustment information acquisition unit 224 may receive the second adjustment information from the information processing device 20. Specifically, for example, the adjustment information generation unit 203 transmits the second adjustment information to the adjustment device 22, and the adjustment information acquisition unit 224 receives the second adjustment information from the information processing device 20. In this case, the output control unit 205 may display, on the terminal device 21, information that allows the customer to identify the adjustment device 22 as the transmission destination. For example, the information that can identify the adjustment device 22 as the transmission destination may be a number of the adjustment device 22 or the like, may be information indicating the position of the adjustment device 22, or is not particularly limited.

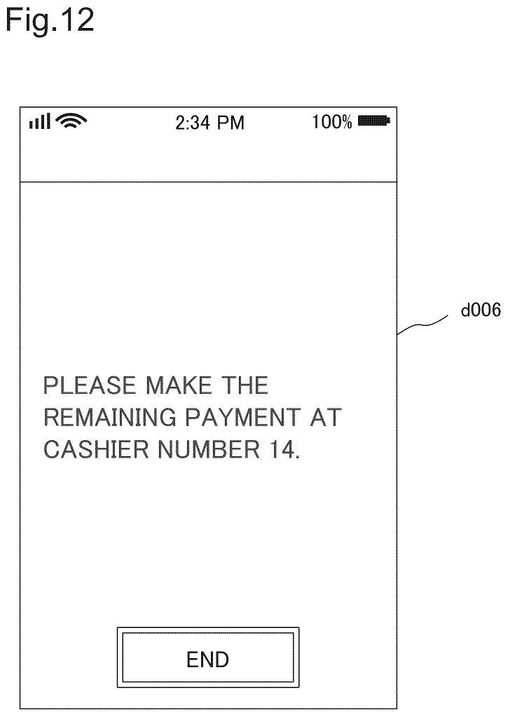

FIG. 12 is an explanatory diagram illustrating a display example of identification information about the adjustment device 22 that makes a payment of the second amount of money. The output unit 213 displays a screen d006 including the number of the adjustment device 22 that makes a payment of the two amounts of money as the identification information about the adjustment device 22. The screen d006 may include, for example, an “END” button for ending the display of the screen d006 after the payment by the adjustment device 22 is completed.

For example, the adjustment information acquisition unit 224 of the adjustment device 22 acquires the second adjustment information by receiving the second adjustment information. In such a case, in the adjustment device 22, the second reception unit 221 may receive an instruction to start the payment by an operation by the customer or the store clerk.

As another method of the adjustment information acquisition unit 224 acquiring the second adjustment information, the adjustment information acquisition unit 224 may acquire the second adjustment information via the terminal device 21. Specifically, for example, the adjustment information generation unit 203 may cause the terminal device 21 to output a code with which the adjustment device 22 can acquire the second adjustment information to using the output control unit 205. The code may be represented by a character, a symbol, a combination thereof, a one-dimensional code, or a two-dimensional code. The code may include the second adjustment information itself, or may include identification information about the second adjustment information.

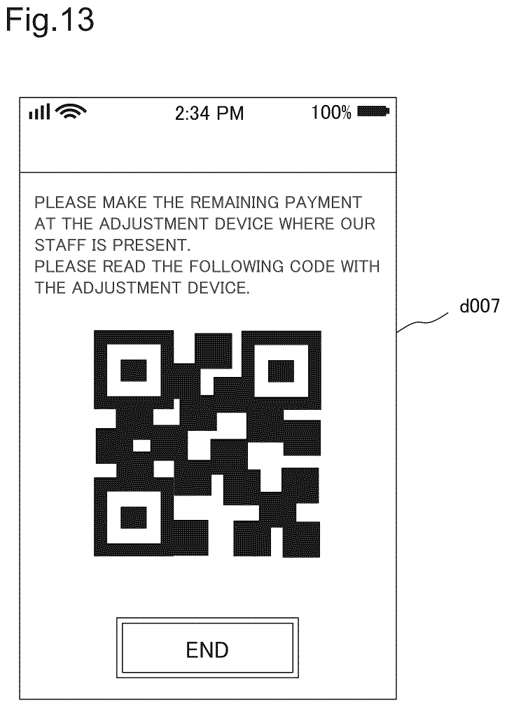

FIG. 13 is an explanatory diagram illustrating a display example of a code. The output unit 213 displays a code with which the adjustment device 22 can acquire the second adjustment information on the display device of the terminal device 21. In FIG. 13, a code is represented by a two-dimensional code on a screen d007.

Then, for example, the adjustment information acquisition unit 224 of the adjustment device 22 may acquire the second adjustment information by reading the code displayed on the terminal device 21. For example, in a case where the code includes the second adjustment information, the adjustment information acquisition unit 224 acquires the second adjustment information included in the code. In a case where the code includes the identification information about the second adjustment information, the adjustment information acquisition unit 224 may acquire the identification information about the second adjustment information included in the code, and acquire the adjustment information from the information processing device 20 based on the identification information.

The second reception unit 221 regards reading the code by the adjustment information acquisition unit 224 as receiving an instruction of a payment of the second amount of money.

Another example in which the adjustment information acquisition unit 224 acquires the second adjustment information via the terminal device 21 will be described. For example, the adjustment information generation unit 203 transmits the second adjustment information to the terminal device 21. Then, the adjustment information acquisition unit 224 may acquire the second adjustment information from the terminal device 21 by wireless communication with the terminal device 21 or the like. The second reception unit 221 regards acquiring the second adjustment information from the terminal device 21 by the adjustment information acquisition unit 224 as receiving an instruction of a payment of the second amount of money.

Next, after the adjustment information acquisition unit 224 acquires the second adjustment information, the first payment unit 222 of the adjustment device 22 makes a payment based on the second adjustment information. The first payment unit 222 transmits the payment result to the information processing device 20. The method of payment in the first payment unit 222 is not particularly limited. For example, the method of payment in the first payment unit 222 is not particularly limited, but may be payment that cannot be made via the terminal device 21. In the case of the manned adjustment device 22, for example, the payment method in the first payment unit 222 may be a payment that requires the operation by the store clerk. For example, examples of the payment requiring the operation by the store clerk include payment using a paper another store gift certificate, payment using a card cash voucher, and the like. This is because the store clerk is required to collect the another store gift certificate of paper in the payment using the another store gift certificate of paper. In the payment using the card cash voucher, it may be necessary to read the card cash voucher by the store clerk operation a dedicated device.

Then, the sales accounting unit 207 counts the sales in this transaction according to the result of payment with each of the first payment unit 222 and the second payment unit 206. For example, the sales accounting unit 207 may account for the result of each payment as a payment at the terminal device 21. In a case where another store gift certificate is used in the adjustment device 22, the sales accounting unit 207 may count the sales in such a way that use of the another store gift certificate can be identified.

The receipt issuing unit 223 issues a receipt related to the transaction. The receipt may be a paper receipt or an electronic receipt. For example, the first amount of money and the second amount of money are identified and displayed on the receipt. For example, a payment method for each amount of money is displayed on the receipt together with the amount of money.

In the above example, an example in which the first amount of money is received by the operation by the customer is described. Next, an example in which the second amount of money is received and the first amount of money is received by subtracting the second amount of money from the purchase amount of money will be described. The second amount of money is an amount of money to be settled by the adjustment device 22, and is, for example, an amount of money to be paid in cash, an amount of money of portable cash voucher, or the like, and is not particularly limited.

The output control unit 205 displays, on the terminal device 21, a screen where the second amount of money can be input. The output unit 213 displays a screen where the second amount of money can be input on the display device of the terminal device 21. The amount reception unit 212 receives an input of the second amount of money. As a result, the amount reception unit 212 transmits the received second amount of money to the information processing device 20. An example in which the amount of paper cash voucher is input will be described.

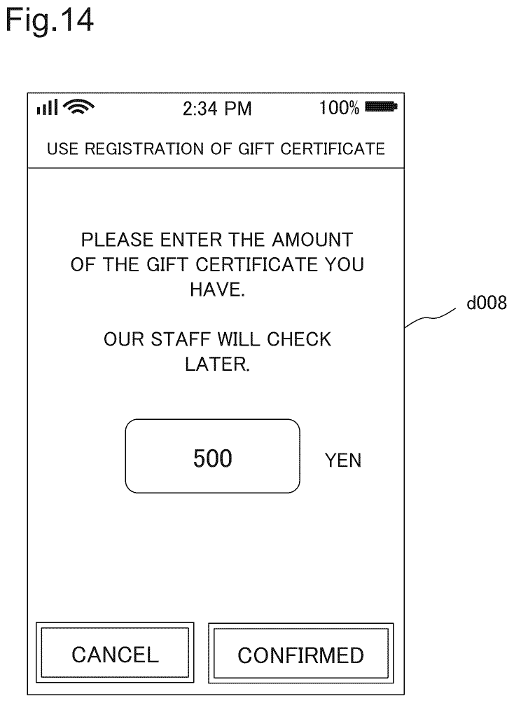

FIG. 14 is an explanatory diagram illustrating an input example of the amount of paper cash vouchers. The output control unit 205 displays, on the terminal device 21, a screen d008 including an input field in which the amount of paper cash vouchers can be input as the second amount of money. The output unit 213 displays a screen d008 where the amount of paper cash vouchers can be input as the second amount of money on the display device of the terminal device 21.

The screen d008 includes, for example, an input field in which the amount of the another store gift certificate can be input, a “CANCEL” button, and a “CONFIRMED” button. When the “CANCEL” button is tapped, the “CANCEL” button may be, for example, a button for returning to the list screen of the list or a button for ending the transaction.

When the “CONFIRMED” button is tapped, the amount reception unit 212 receives the amount of money input in the input field as the second amount of money. Then, the amount reception unit 212 transmits the received second amount of money to the information processing device 20. The first reception unit 202 receives the second amount of money. The first reception unit 202 sets the difference between the second amount of money and the purchase amount of money as the first amount of money. The amount reception unit 212 may transmit the amount obtained by subtracting the second amount of money from the purchase amount of money to the information processing device 20 as the first amount of money. The first reception unit 202 receives the first amount of money.

Hereinafter, the processing of paying the first amount of money and the processing of paying the second amount of money via the adjustment device 22 are as described above, and detailed description thereof will be omitted. However, for example, in a case where the another store gift certificate is used, a store clerk is required to check and collect the another store gift certificate. For this reason, in a case where the another store gift certificate is used, the adjustment device 22 is the adjustment device 22 operable by the store clerk. Alternatively, even in the case of the adjustment device 22 operable by the customer, the adjustment device 22 is only required to have a function of preventing the payment from being completed until another store gift certificate is collected by the store clerk.

The present invention is not limited to the another store gift certificate, and in the case of payment that requires an operation, check, collection, or the like by a store clerk, a manned adjustment device 22 operable by the store clerk is used. For example, in a case where the adjustment information generation unit 203 transmits adjustment information related to the second amount of money to the adjustment device 22, when the payment requires an operation, check, collection, or the like by the store clerk, the adjustment information generation unit 203 may select the manned adjustment device 22 from the plurality of adjustment devices 22 to transmit the adjustment information to the selected manned adjustment device 22. In a case where the adjustment information acquisition unit 224 of the adjustment device 22 acquires the adjustment information via the terminal device 21, the adjustment information generation unit 203 may transmit, to the terminal device 21, adjustment information that allows the manned adjustment device 22 to make a payment, the adjustment information being related to the second amount of money. The adjustment information that allows the manned adjustment device 22 to make a payment may include, for example, information indicating that a payment made by the manned adjustment device 22 is necessary. In a case where the adjustment information acquisition unit 224 of the manned adjustment device 22 acquires the adjustment information from the terminal device 21, when the adjustment information is included, the first payment unit 222 makes a payment of the second amount of money based on the acquired adjustment information. On the other hand, in a case where the adjustment information acquisition unit 224 of the unattended adjustment device 22 acquires the adjustment information from the terminal device 21, when the adjustment information is included, the unattended adjustment device 22 may make a notification that the payment cannot be made.

For example, the sales accounting unit 207 may count the result of the payment at the adjustment device 22 as the payment at the terminal device 21.

As described above, even in a case where the customer uses the manned adjustment device 22 to use the another store gift certificate, the information processing device 20 makes a partial payment in advance using the terminal device 21, so that it is possible to save labor of the store clerk.

In the above example, an example in which the amount reception unit 212 receives the numerical value of the second amount of money by the input by the customer is described. However, the present invention is not limited to this example. For example, the amount reception unit 212 may receive identification information that allows the second amount of money to be identified by operation by the customer. For example, the identification information may be identification information for identifying a portable cash voucher. The identification information for identifying the portable cash voucher is not particularly limited, and is a code such as a number or a symbol of the cash voucher. The identification information that can identify the second amount of money may be represented by a one-dimensional code or a two-dimensional code. Then, the amount reception unit 212 transmits the received identification information to the information processing device 20. The first reception unit 202 receives the received identification information. The first reception unit 202 sets a difference between the second amount of money identified by the identification information and the purchase amount of money as the first amount of money. As the process of identifying the second amount of money from the identification information, the identification information and the amount of money may be stored in advance in association with each other as in a gift certificate DB or the like, and the first reception unit 202 may identify the amount of money associated with the identification information from the gift certificate DB, as in an in-house gift certificate to be described later. Alternatively, as another process, the identification information may include information about the amount of money, and the first reception unit 202 may acquire the information about the amount of money from the identification information.

### Operation Example of Each Device in Case of Paying First Amount of Money

First, the overall operation of the information processing device 20 will be described.

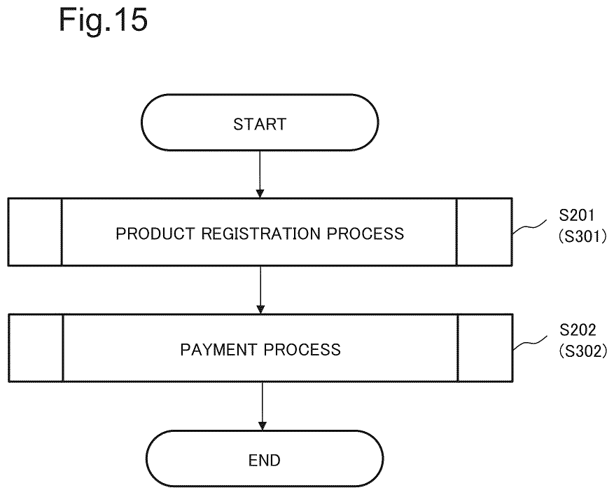

FIG. 15 is a flowchart illustrating an operation example of the information processing device 20. The information processing device 20 performs a product registration process (step S201). Next, the information processing device 20 performs a payment process (step S202). Details of each process will be described in detail with reference to the drawings. A credit payment will be described as an example of the payment made by the operation of the terminal device 21. As the timing at which the amount reception unit 212 receives the first amount of money, the timing after the product registration is completed will be described as an example, but the present invention is not limited to the timing of this example.

Since the terminal device 21 operates according to the control of the information processing device 20, as in the information processing device 20, the terminal device operates in the order illustrated in FIG. 15. Therefore, although a description of the entire operation example by the terminal device 21 is omitted, an operation example of each process will be described. In FIG. 15, steps S301 and S302 in ( ) are steps performed by the terminal device 21, and are used for description of each process performed by the terminal device 21 described later.

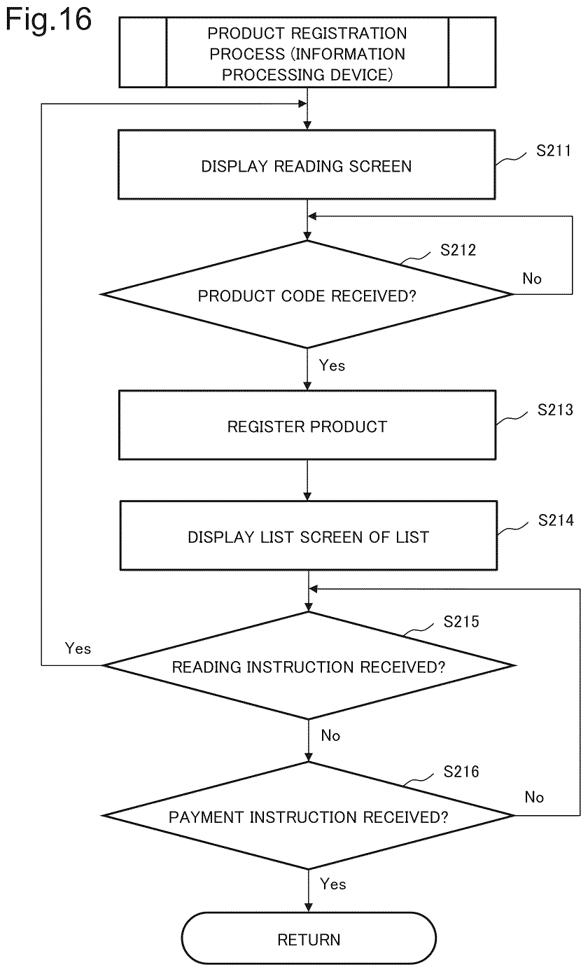

FIG. 16 is a flowchart illustrating an example of a specific processing procedure of the product registration process (step S201) by the information processing device 20. The output control unit 205 displays, on the terminal device 21, a reading screen in order to cause the terminal device 21 to acquire the product identification information (step S211). An example of the reading screen is the reading screen d001 illustrated in FIG. 7. The identification information acquisition unit 201 determines whether a product code has been received as the product identification information (step S212). When the new product code is not received (step S212: No), the identification information acquisition unit 201 returns the process to step S212.

When the identification information acquisition unit 201 receives the product code (step S212: Yes), the registration unit 204 registers the product (step S213). In step S213, the registration unit 204 registers the product code in the list of customers included in the list DB 2002.

The output control unit 205 displays, on the terminal device 21, a list screen of the list after registration (step S214). Next, the output control unit 205 determines whether a reading instruction has been received (step S215). When the reading instruction has been received (step S215: Yes), the output control unit 205 returns the process to step S211. On the other hand, when the reading instruction has not been received (step S215: No), the second payment unit 206 determines whether the payment instruction has been received (step S216). The second payment unit 206 may determine whether the product registration has been completed depending on whether the payment instruction has been received. For example, in a case where the “PAY” button is tapped on the list screen displayed on the terminal device 21, the second payment unit 206 may determine that the product registration is completed by receiving the payment instruction from the terminal device 21.

When the payment instruction has not been received (step S216: No), the output control unit 205 returns the process to step S215. On the other hand, in a case where the payment instruction has been received (step S216: Yes), the product registration process is ended, and the process returns.

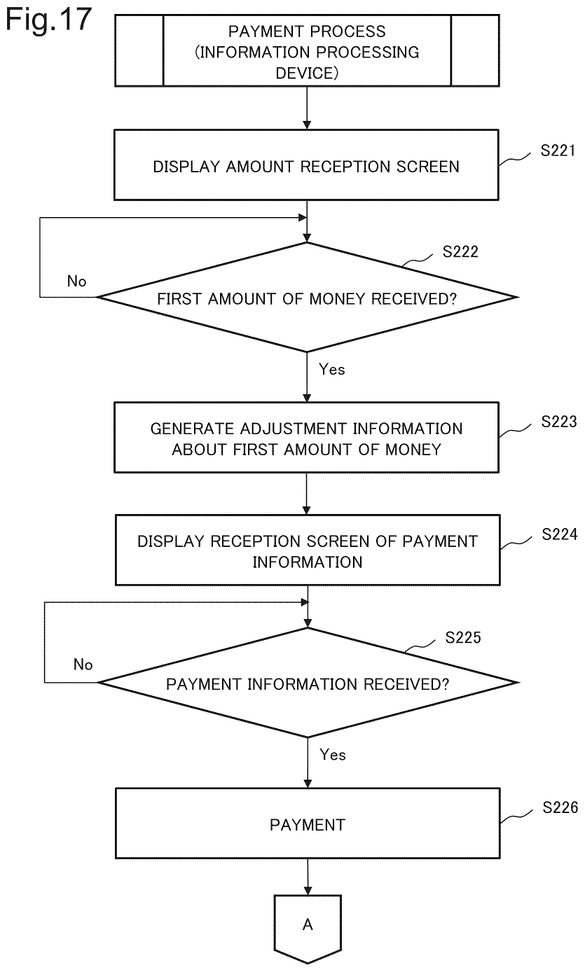

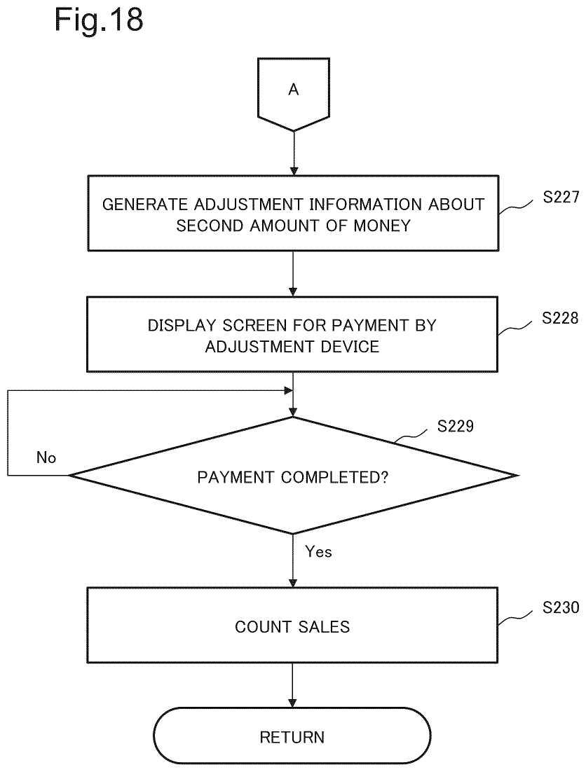

FIGS. 17 and 18 are flowcharts illustrating an example of a specific processing procedure of the payment process (step S202). The output control unit 205 displays an amount reception screen (step S221).

The first reception unit 202 determines whether the first amount of money is received (step S222). In step S222, when receiving the first amount of money, the first reception unit 202 receives an instruction of a payment of the first amount of money. When the first reception unit 202 does not receive the first amount of money (step S222: No), the first reception unit 202 returns the process to step S222. When the first reception unit 202 receives the first amount of money (step S222: Yes), the adjustment information generation unit 203 generates adjustment information related to the first amount of money (step S223).

Then, the output control unit 205 displays a payment information reception screen based on the adjustment information (step S224). The second payment unit 206 determines whether the payment information has been received (step S225). When the payment information has not been received (step S225: No), the second payment unit 206 returns the process to step S225. When the payment information is received (step S225: Yes), the second payment unit 206 pays the first amount of money (step S226).

Next, the adjustment information generation unit 203 generates adjustment information related to the second amount of money that is the difference between the total purchase amount of money and the first amount of money (step S227). The output control unit 205 displays, on the terminal device 21, a screen for a payment by the adjustment device 22 (step S228). The sales accounting unit 207 determines whether payment has been completed (step S229). When the payment has not been completed (step S229: No), the sales accounting unit 207 returns the process to step S229. When the payment has been completed (step S229: Yes), the sales accounting unit 207 counts sales (step S230), and the process returns. As a result, the information processing device 20 ends each process.

Next, the process by the terminal device 21 will be described. Although not specifically described, the output unit 213 outputs screen display and information under the control of the output control unit 205.

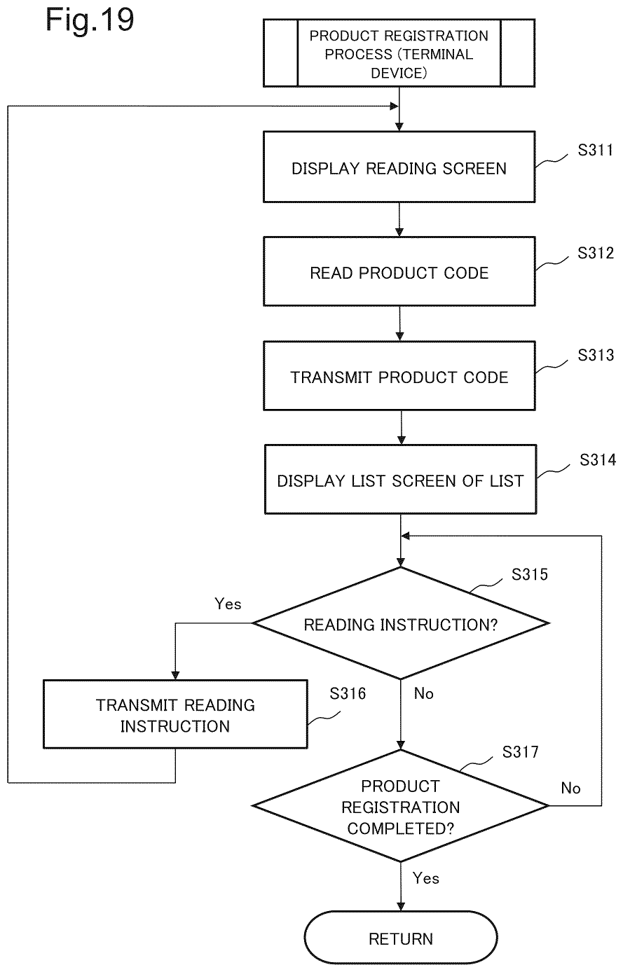

FIG. 19 is a flowchart illustrating an example of a specific processing procedure of the product registration process (step S301) by the terminal device 21. The output unit 213 displays a reading screen (step S311). The identification information reading unit 211 recognizes a barcode of a product via the imaging device of the terminal device 21 and reads a product code represented by the barcode (step S312). Then, the identification information reading unit 211 transmits the product code to the information processing device 20 (step S313). Next, the output unit 213 displays a list screen of the list (step S314).

The instruction reception unit 215 determines whether a reading instruction has been received (step S315). When receiving the reading instruction (step S315: Yes), the instruction reception unit 215 transmits the reading instruction to the information processing device 20 (step S316), and returns the process to step S311. When the reading instruction has not been received (step S315: No), the instruction reception unit 215 determines whether product registration has been completed (step S317). In step S317, the instruction reception unit 215 may determine whether the product registration is completed depending on whether the payment instruction is received. For example, when receiving the payment instruction, the instruction reception unit 215 determines that the product registration is completed. When the product registration is not completed (step S317: No), the instruction reception unit 215 returns the process to step S314. On the other hand, when the product registration is completed (step S317: Yes), the instruction reception unit 215 returns. As a result, the product registration process ends, and the terminal device 21 shifts to the payment process.

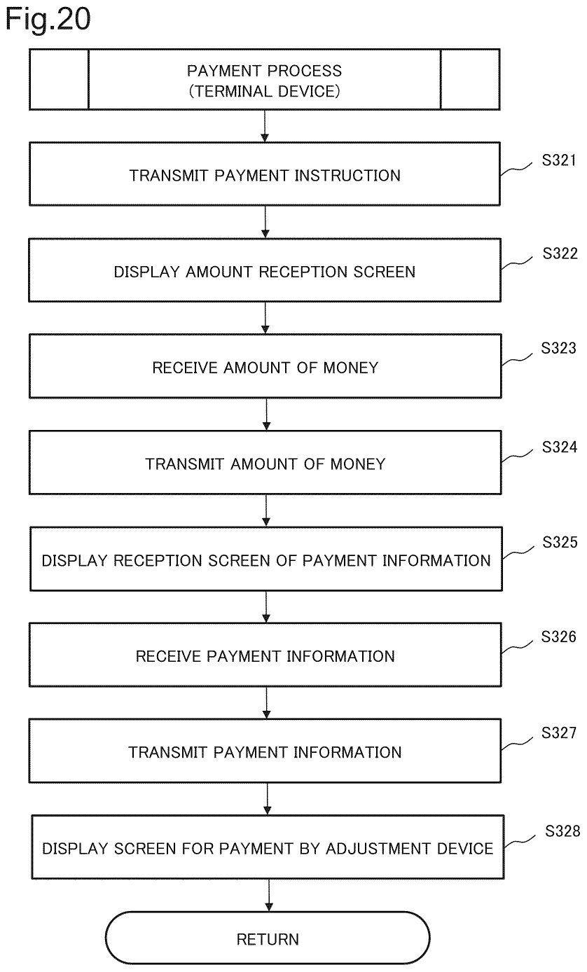

FIG. 20 is a flowchart illustrating an example of a specific processing procedure of the payment process (step S302) by the terminal device 21. The instruction reception unit 215 transmits the payment instruction to the information processing device 20 (step S321). Then, the output unit 213 displays a screen for receiving the amount of money on the terminal device 21 (step S322).

The amount reception unit 212 receives an amount of money (step S323). In step S323, the amount reception unit 212 may receive the first amount of money by the operation by the customer. In step S323, the amount reception unit 212 may receive the second amount of money, and receive an amount obtained by subtracting the second amount of money from the total purchase amount of money as the first amount of money.

Then, the amount reception unit 212 transmits the first amount of money to the information processing device 20 (step S324). The second amount of money may be transmitted to the information processing device 20, and the first reception unit 202 may calculate the first amount of money.

The output unit 213 displays a screen for receiving payment information related to the payment method (step S325). The payment information reception unit 214 receives the payment information (step S326). The payment information reception unit 214 transmits the payment information to the information processing device 20 (step S327). The output unit 213 displays the screen for the payment on the adjustment device 22 (step S328), and the process returns. In step S328, the output unit 213 may display a screen including a code with which the adjustment device 22 can acquire the adjustment information, or may display an identifier such as a number or a place of the adjustment device 22.

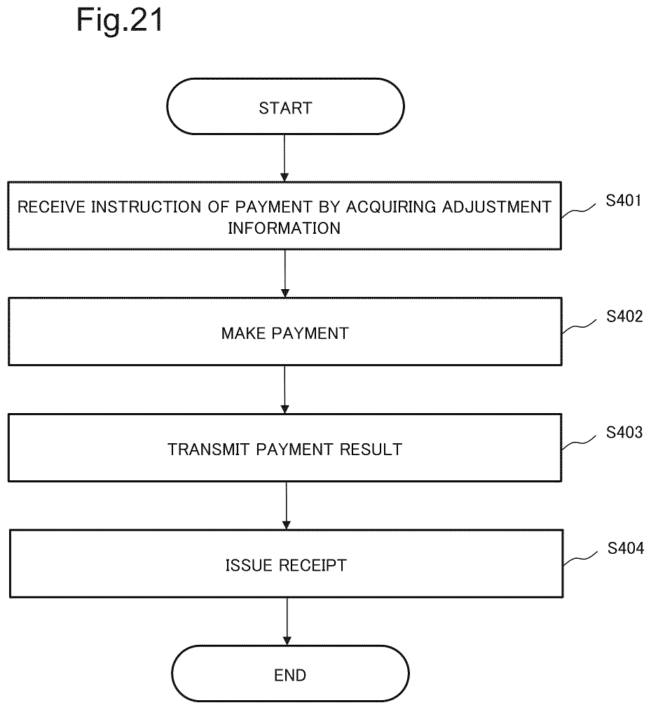

FIG. 21 is a flowchart illustrating an operation example of the adjustment device 22. An example will be described in which the adjustment information acquisition unit 224 reads the adjustment information by the operation by the customer or the store clerk, and the second reception unit 221 receives an instruction of a payment. The second reception unit 221 acquires the adjustment information via the adjustment information acquisition unit 224 according to the operation by the customer or the store clerk, thereby receiving an instruction of a payment of the second amount of money (step S401). In step S401, for example, the second reception unit 221 regards reading the code with which it is possible to acquire the adjustment information via the adjustment information acquisition unit 224 by the operation by the customer or the store clerk as receiving the instruction of a payment of the second amount of money.

The first payment unit 222 makes a payment of the second amount of money based on the adjustment information (step S402). Then, the first payment unit 222 transmits the payment result to the information processing device 20 (step S403). As a result, the information processing device 20 can count the sales. Then, the receipt issuing unit 223 issues a receipt (step S404), and ends the process.

As described above, the adjustment information acquisition unit 224 may acquire the adjustment information by receiving the adjustment information from the information processing device 20, and the second reception unit 221 may receive an instruction to start the payment as the instruction of the payment of the second amount of money by the operation by the customer or the store clerk.

### <Discount of First Amount of Money>

Next, an example in which the information processing device 20 gives a discount of the first amount of money received in the terminal device 21 will be described. Examples of the discount include the point and the in-house gift certificate.

### <Point Discount>

First, for example, an example in which the first reception unit 202 acquires an amount of money by which a discount is given by using a point as the first amount of money will be described. For ease of explanation, a specific example in which one point corresponds to one yen will be described, but the conversion of points into currency is not particularly limited.

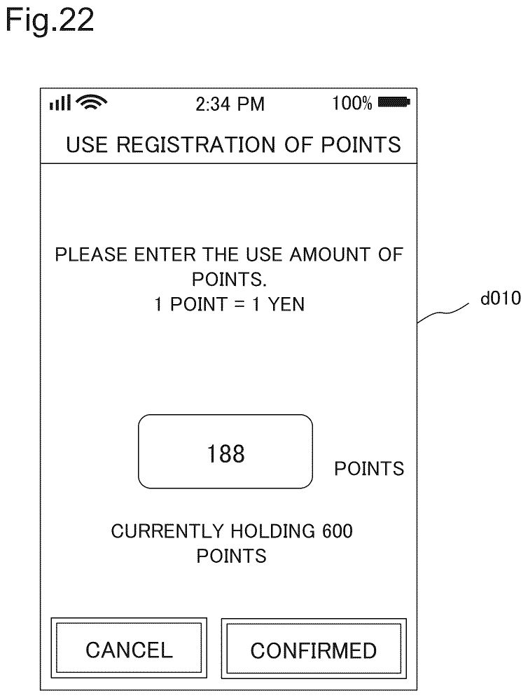

FIG. 22 is an explanatory diagram illustrating a registration example of the amount of use of points. For example, the output control unit 205 displays, on the terminal device 21, a screen d010 that allows the amount of use of points as the first amount of money to be received. The output unit 213 displays the screen d010 on the display device of the terminal device 21.

In FIG. 22, a screen d010 includes an input field in which the number of points to be used can be input, a “CONFIRMED” button, and a “CANCEL” button. The “CANCEL” button may be, for example, a button for cancelling the use of points and returning to the list screen of the list, or a button for ending the transaction. The “CONFIRMED” button is a button for receiving the number of points to be used input in the input field. As illustrated in FIG. 22, the screen d010 may include information such as conversion of points into the amount and the number of points currently held by the customer.

For example, when the “CONFIRMED” button is tapped, the amount reception unit 212 receives the number of points to be used input in the input field as the first amount of money. The amount reception unit 212 transmits the first amount of money to the information processing device 20. The first reception unit 202 receives the first amount of money. As a result, the first reception unit 202 receives an instruction of a payment of the first amount of money.

The adjustment information generation unit 203 generates adjustment information related to a payment of the second amount of money obtained by subtracting the first amount of money from the total purchase amount of money. The total purchase amount of money in the case of the discount may be the tax-included total purchase amount of money or the tax-excluded total purchase amount of money. In the case of the tax-excluded total purchase amount of money, the amount obtained by adding the tax to the amount obtained by subtracting the first amount of money from the tax-excluded total purchase amount of money is the second amount of money. On the other hand, in the case of the tax-included total purchase amount of money, the amount obtained by subtracting the first amount of money from the tax-included total purchase amount of money is the second amount of money. For example, the adjustment information includes information such as a discount amount that is the first amount of money and the second amount of money.

The adjustment information acquisition unit 224 of adjustment device 22 acquires the adjustment information. The acquisition method here may be performed via the terminal device 21 or may be transmitted from the information processing device 20, and is not particularly limited as described in the case where the information processing device 20 pays the first amount of money. The process in which the second reception unit 221 receives the instruction of a payment and the process of payment by the adjustment device 22 are not particularly limited as described in the case where the information processing device 20 pays the first amount of money.

### <Discount of Amount of In-House Gift Certificate>

Next, an example in which the first reception unit 202 receives the amount of the in-house gift certificate as the first amount of money will be described. For example, the in-house gift certificate may be treated as a discount. The customer is not aware of the difference between the another store gift certificate and the in-house gift certificate. However, in the case of the in-house gift certificate, the discount may be applied by the operation by the customer on the terminal device 21. Therefore, as for the registration of the discount that can be operated by the customer, it is possible to save labor of the store clerk by the customer performing the operation.

Specifically, the output control unit 205 displays, on the terminal device 21, a screen that allows the amount of the in-house gift certificate to be received as the first amount of money. For example, the screen may be a screen similar to the screen illustrated in FIG. 14. The output unit 213 displays this screen. Then, the amount reception unit 212 receives the amount of the in-house gift certificate as the first amount of money.

In the case of an in-house gift certificate, the amount of money or the like may be managed by identification information or the like of the in-house gift certificate. In such a case, the amount reception unit 212 may receive identification information about the in-house gift certificate. The method of the amount reception unit 212 receiving the identification information may be reading of the identification information about the in-house gift certificate via various readers by the operation by the customer, or may be inputting of the identification information by the operation by the customer.

It is assumed that information and the like in which the identification information about the in-house gift certificate, the amount of the in-house gift certificate, and the validity are associated with each other are stored in the in-house gift certificate DB or the like. The validity may be represented by valid, invalid, provisional invalid or the like.

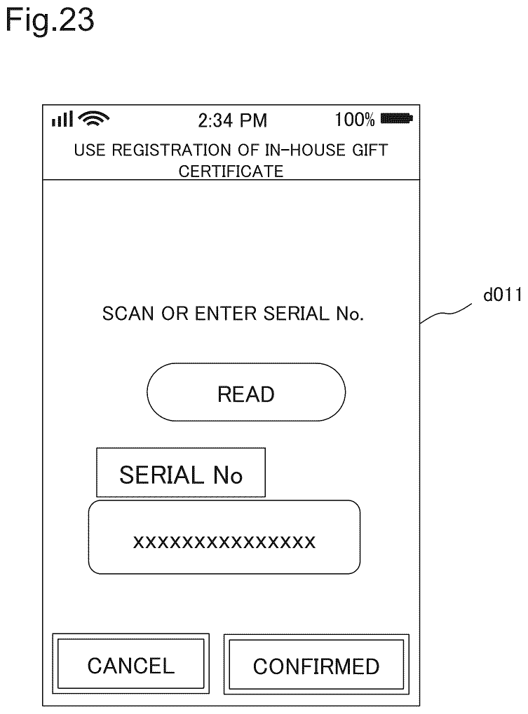

FIG. 23 is an explanatory diagram illustrating an example of receiving identification information about an in-house gift certificate.

In FIG. 23, the identification information about the in-house gift certificate is represented by the serial number. For example, the output control unit 205 displays, on the terminal device 21, a screen d011 for receiving the identification information about the in-house gift certificate. The output unit 213 displays, on the display device of the terminal device 21, the screen d011 for receiving the identification information about the in-house gift certificate. The screen d011 may include, for example, a “READ” button, an input field of a serial number, a “CONFIRMED” button, a “CANCEL” button, and the like.

For example, when the “CONFIRMED” button is tapped, the amount reception unit 212 receives the serial number input in the input field as the identification information about the in-house gift certificate. Then, the amount reception unit 212 transmits the received identification information about the in-house gift certificate to the information processing device 20. The first reception unit 202 receives the identification information about the in-house gift certificate.

In FIG. 23, when the “READ” button is tapped, the instruction reception unit 215 may transmit a reading instruction for reading the serial number as the identification information about the in-house gift certificate to the information processing device 20. Then, the output control unit 205 of the information processing device 20 may display the reading screen of the serial number on the terminal device 21. The output unit 213 displays the reading screen of the serial number on the display device of the terminal device 21. For example, in a case where the serial number is indicated by the barcode, the amount reception unit 212 can read the serial number represented by the barcode by recognizing the barcode via the imaging device of the terminal device 21. Then, the amount reception unit 212 transmits the read serial number to the information processing device 20 as identification information about the in-house gift certificate. The first reception unit 202 receives the identification information about the in-house gift certificate.

The determination unit 208 searches for the identification information about the in-house gift certificate from the in-house gift certificate DB. In a case where the identification information is searched for, the determination unit 208 verifies the validity of the in-house gift certificate identified by the identification information. In a case where the in-house gift certificate is invalid, the determination unit 208 notifies the customer that it is not available. The invalidating unit 209 may perform temporary invalidation in a case where the in-house gift certificate is valid.

The first reception unit 202 acquires the amount of the in-house gift certificate identified by the identification information as the first amount of money. Then, the adjustment information generation unit 203 generates the adjustment information for making a payment of the amount obtained by subtracting the first amount of money from the purchase amount of money using the amount of the in-house gift certificate as the first amount of money. The subsequent processing may be similar to that in the example of the point discount, and a detailed description thereof will be omitted.

After the payment in the adjustment device 22 is completed, the invalidating unit 209 may invalidate the in-house gift certificate that has been temporarily invalidated. As a result, for example, in a case where the customer tries to use the in-house gift certificate, the in-house gift certificate is invalid and cannot be used. Further, the store clerk may collect the in-house gift certificate, or the customer may put the in-house gift certificate into the collection box. Therefore, the adjustment device 22 may be the manned adjustment device 22 or the unattended adjustment device 22.

For example, the sales accounting unit 207 may count the result of the payment at the adjustment device 22 as the payment at the terminal device 21.

In a case where the in-house gift certificate is used as a discount, there is a case where the in-house gift certificate of an amount larger than the purchase amount of money cannot be used. In such a case, the determination unit 208 may determine whether the amount of the in-house gift certificate is larger than the purchase amount of money when the in-house gift certificate is valid. When the amount is larger than the purchase amount of money, the determination unit 208 may notify the customer that the in-house gift certificate is not available because the amount is larger than the purchase amount of money. For example, the output control unit 205 may display this fact on the screen d011 of FIG. 23.

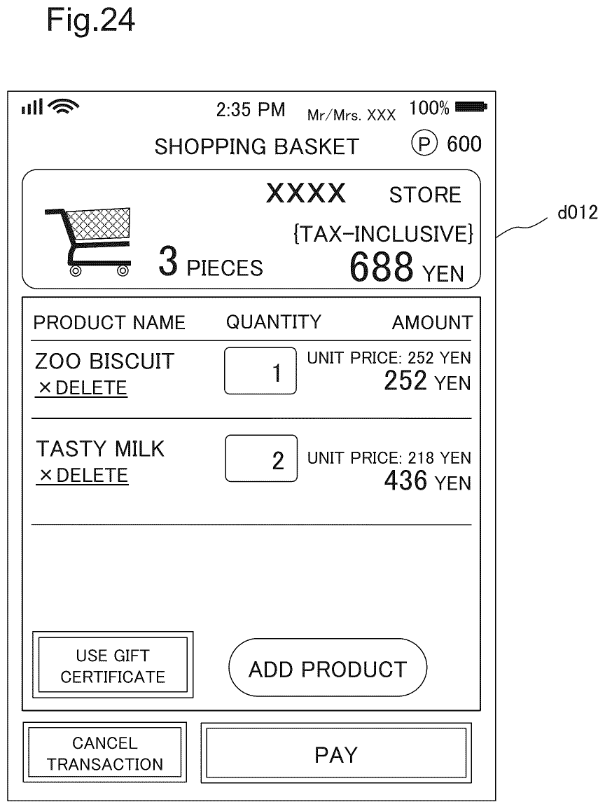

The timing at which the first reception unit 202 acquires the amount of the in-house gift certificate and the identification information about the in-house gift certificate via the amount reception unit 212 is not particularly limited, and may be after the product registration is completed, during the product registration, or before the product registration. An example in which the use of the in-house gift certificate is registered on a list screen of products registered on the list will be described with reference to FIG. 24.

FIG. 24 is an explanatory diagram (part 1) illustrating another example of the list screen. For example, in FIG. 24, in the output control unit 205, a list screen d002 further includes a “USE GIFT CERTIFICATE” button that is added in the list screen d012 illustrated in FIG. 8. When the “USE GIFT CERTIFICATE” button is tapped, the instruction reception unit 215 transmits an instruction to register the in-house gift certificate to the information processing device 20. The instruction to register the in-house gift certificate is an instruction for inputting the amount of the in-house gift certificate. That is, the instruction to register the in-house gift certificate is an instruction for inputting the amount of the in-house gift certificate as the first amount of money. The output control unit 205 of the information processing device 20 displays, on the terminal device 21, a screen for receiving the identification information and the amount of money of the in-house gift certificate. Then, the output unit 213 displays a screen for receiving the identification information and the amount of money of the in-house gift certificate. The amount reception unit 212 receives the identification information and the amount of money of the in-house gift certificate to transmit the them to the information processing device 20, and the first reception unit 202 receives the identification information and the amount of money of the in-house gift certificate. As a result, the first reception unit 202 can receive an instruction of a payment of the first amount of money. An example in which the amount reception unit 212 receives the identification information and the amount of money of the in-house gift certificate is as described above.

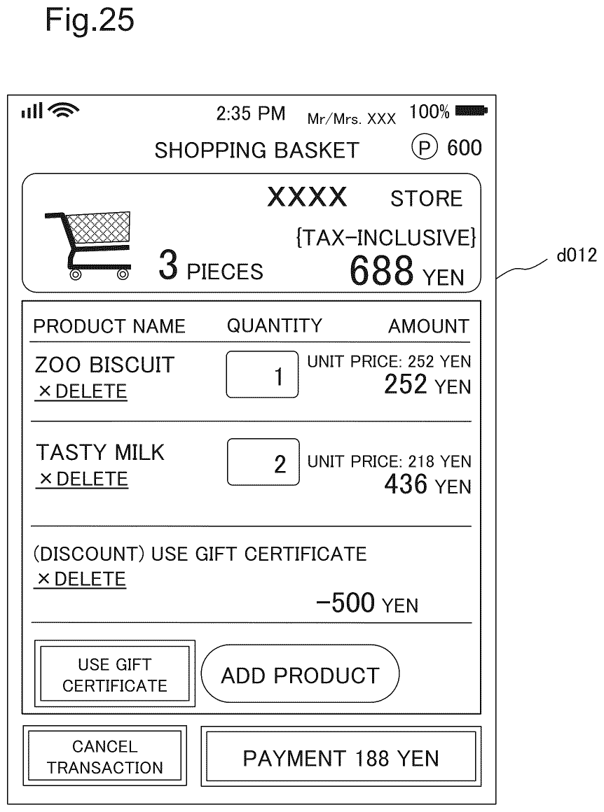

FIG. 25 is an explanatory diagram (part 2) illustrating another example of the list screen. In FIG. 25, the list screen d012 includes a discount amount of the amount of the in-house gift certificate registered unlike FIG. 24. In this manner, the customer can check the discount amount. When receiving the tap of the “payment button”, the instruction reception unit 215 transmits a payment instruction to the information processing device 20. Then, the adjustment information generation unit 203 generates adjustment information related to the second amount of money obtained by subtracting the first amount of money from the purchase amount of money. The following description may be similar to that in the example of the point discount, and a detailed description thereof will be omitted.

This is the end of the description of the discount with the in-house gift certificate. In a case where the customer desires to use the in-house gift certificate and the another store gift certificate, the first reception unit 202 may receive the amount of money of the another store gift certificate after receiving the amount of money or the identification information about the in-house gift certificate by the amount reception unit 212. Alternatively, the first reception unit 202 may receive the amount of money or the identification information about the in-house gift certificate after receiving the amount of money of the another store gift certificate by the amount reception unit 212.

The amount reception unit 212 may receive the selection of the type of gift certificate, and may receive the amount of money or the identification information about the selected type of gift certificate.

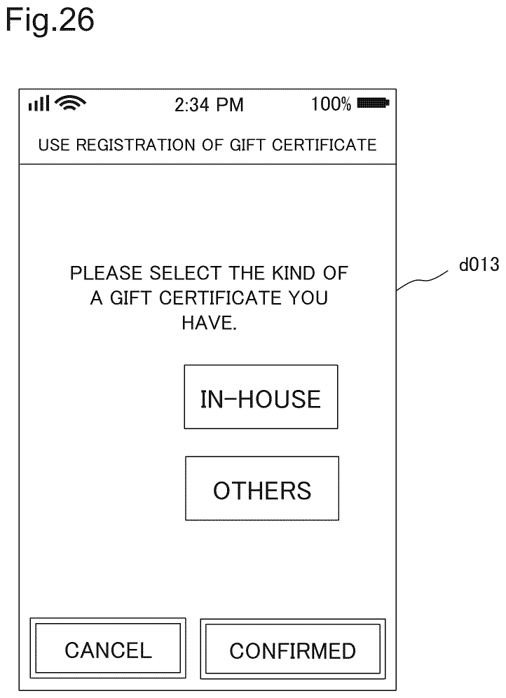

FIG. 26 is an explanatory diagram illustrating a selection example of a type of a gift certificate. The output control unit 205 displays a screen d013 that allows the type of gift certificate to be selected on the terminal device 21. The output unit 213 displays the screen d013 on the display device of the terminal device 21. In FIG. 26, a screen d013 includes an “IN-HOUSE” button for inputting the amount of the in-house gift certificate, an “ANOTHER COMPANY” button for inputting the amount of the another store gift certificate, a “CONFIRMED” button, and a “CANCEL” button.

An example of receiving the amount of money or the identification information is as described above, and thus a detailed description thereof will be omitted.

### Operation Example of Each Device in Case of Discount of First Amount of Money

The operations of the information processing device 20 and the terminal device 21 may be different in the payment process illustrated in FIG. 15, compared with the case where the first amount of money is paid. However, the first amount of money may be received during product registration, but detailed description of this example will be omitted.

Since the operation of the adjustment device 22 is the same as that in the case of paying the first amount of money, detailed description thereof will be omitted.

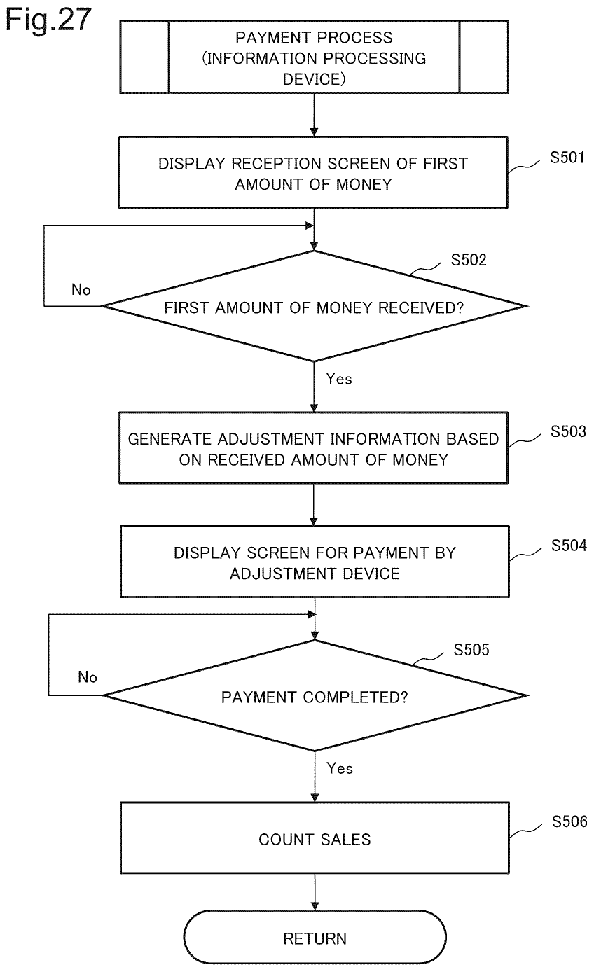

FIG. 27 is a flowchart illustrating an example of the specific processing procedure in the payment process (step S202) by the information processing device 20 in a case where the first amount of money is discounted. The output control unit 205 displays a screen for receiving the first amount of money (step S501). The adjustment information generation unit 203 determines whether the first amount of money has been received (step S502). In a case where the first amount of money has not been received (step S502: No), the adjustment information generation unit 203 returns the process to step S502.

When the first amount of money has been received (step S502: Yes), the adjustment information generation unit 203 generates adjustment information based on the second amount of money obtained by subtracting the first amount of money from the total purchase amount of money (step S503). Next, the output control unit 205 displays a screen for payment by the adjustment device 22 (step S504).

The sales accounting unit 207 determines whether the payment by adjustment device 22 has been completed (step S505). When the payment by adjustment device 22 has not been completed (step S505: No), the sales accounting unit 207 returns the process to step S505. Then, when the payment by the adjustment device 22 is completed (step S505: Yes), the sales accounting unit 207 counts the sales (step S506), and the process returns. Accordingly, the information processing device 20 ends the process.

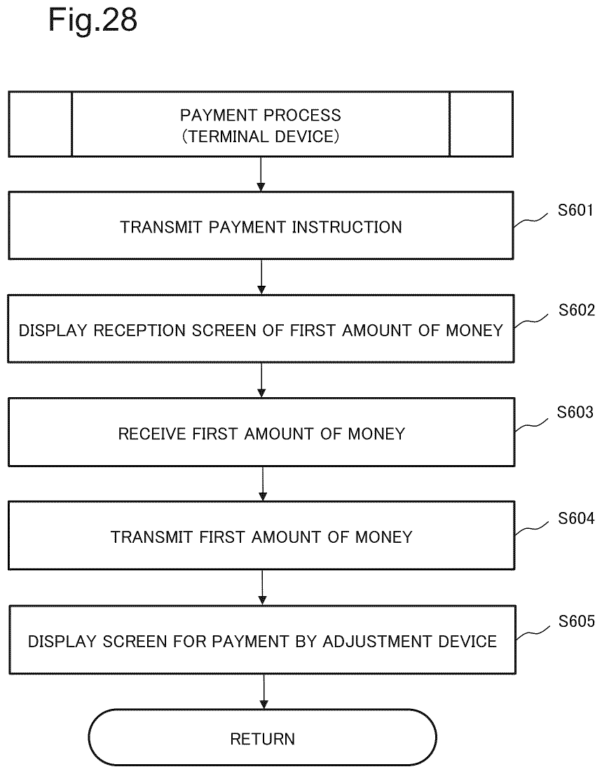

FIG. 28 is a flowchart illustrating an example of a specific processing procedure of a payment process (step S302) by the terminal device 21 in a case where the first amount of money is discounted.

Instruction reception unit 215 transmits the payment instruction (step S601). The output unit 213 displays a screen for receiving the first amount of money (step S602). The amount reception unit 212 receives the first amount of money (step S603). The amount reception unit 212 transmits the received first amount of money (step S604). Then, the output unit 213 displays a screen for payment by the adjustment device 22 (step S605), the process returns. Accordingly, the terminal device 21 ends the process.

As described above, in the second example embodiment, in a case where the payment of the second amount of money is, for example, a payment of a paper gift certificate, the adjustment device 22 makes a payment of the second amount of money by the operation by the store clerk. The paper gift certificate may be collected by a store clerk. For this reason, it is possible to save labor of the store clerk by making the payment that can be settled via the terminal device 21 by the operation by the customer.

The payment of the second amount of money via the adjustment device 22 may be a cash payment. This enables different payments to be made.

The terminal device 21 receives the input of the first amount of money by the operation by the customer. Alternatively, the terminal device 21 receives the input of the second amount of money by the operation by the customer, thereby receiving the difference between the purchase amount of money and the second amount of money as the first amount of money. As a result, the amount to be paid by the customer can determine for each payment.

In a case where the information processing device 20 makes a payment of the first amount of money via the terminal device 21, the payment is, for example, at least one of a credit payment, a code payment, and an electronic money payment. In a case where the information processing device 20 makes a discount of the first amount of money via the terminal device 21, the first amount of money is a point and an in-house gift certificate issued by the store. In this manner, the customer can make various payments by his/her operation, and convenience can be improved.

The adjustment device 22 makes a payment of the second amount of money and issues a receipt in which the first amount of money and the second amount of money are identified and displayed.

The description of each example embodiment ends. The example embodiments may be used in combination. For example, the discount and the payment via the terminal device 21 may be combined. In the terminal device 21, part of the first amount of money may be a discount, and the remaining amount of the first amount of money may be a payment. For example, in a case where the purchase amount of money is 1000 yen, 500 yen may be discounted with the in-house gift certificate via the terminal device 21, 100 yen may be paid by credit via the terminal device 21, and 400 yen may be paid by cash via the adjustment device 22. In such a case, the amount reception unit 212 may receive part of the first amount of money and the remaining amount of the first amount of money. The first reception unit 202 can acquire part of the first amount of money and the remaining amount of the first amount of money. Alternatively, the amount reception unit 212 may receive each of part of the first amount of money and the second amount of money by the operation by the customer, and set an amount obtained by subtracting part of the first amount of money and the second amount of money from the purchase amount of money as the remaining amount of the first amount of money. The first reception unit 202 can acquire part of the first amount of money, the remaining amount of the first amount of money, and the second amount of money.

Further, for example, each example embodiment may be modified and used. The modifications will be described below.

### First Modification

For example, an example is described in which the determination unit 208 determines whether the amount of the in-house gift certificate is larger than the purchase amount of money, and in a case where the amount of the in-house gift certificate is larger, notifies the customer of the fact. For example, the determination unit 208 may determine whether the amount of the portable cash voucher is larger than the purchase amount of money, and in a case where the amount of the portable cash voucher is larger, may notify the customer that the amount of the portable cash voucher is larger than the purchase amount of money.

For example, in a case where the amount of credit payment is received as the first amount of money or in a case where the amount of points is received as the first amount of money, similarly, the determination unit 208 may determine whether the received first amount of money is larger than the purchase amount of money, and in a case where the received first amount of money is large, may notify the customer the fact.

Determination unit 208 may determine whether the received first amount of money is larger than the purchase amount of money, and in a case where the first amount of money is larger than the purchase amount of money, may correct the first amount of money to the purchase amount of money.

### Second Modification

The payment of all the amounts may not be completed by the discount or the payment via the terminal device 21 and the payment via one adjustment device 22, and the payment of the remaining amount may be made by another adjustment device 22. For example, in a case where the first adjustment device 22 is the manned adjustment device 22 operated by the store clerk, it takes time and effort for the store clerk. Therefore, the manned adjustment device 22 makes a payment that requires the operation by the store clerk such as of the another store gift certificate, and the adjustment device 22 operated by the customer makes the remaining payment. Accordingly, it is possible to save labor of the store clerk.

Specifically, in a case where the first payment unit 222 of the manned adjustment device 22 pays part of the second amount of money, the adjustment information generation unit 203 further generates adjustment information related to the remaining amount. Then, the second reception unit 221 of the another adjustment device 22 may acquire the adjustment information. Then, the first payment unit 222 of the another adjustment device 22 makes a payment of the remaining amount based on the acquired adjustment information.

### Third Modification

The third modification illustrates another example of the information processing device. In the first and second example embodiments, while an example in which the adjustment device includes the second reception unit is described, for example, the information processing device may include the second reception unit.

For example, in a case where the information processing device 20 includes the second reception unit 221, the second reception unit 221 receives an instruction of a payment of the second amount of money to the adjustment device 22. For example, when the adjustment device 22 receives a payment instruction by the operation by the customer, the payment instruction is transmitted to the information processing device 20. For example, the payment instruction here may include customer identification information. The second reception unit 221 of the information processing device 20 receives the payment instruction including the customer identification information. Then, the adjustment information generation unit 203 identifies the adjustment information related to the second amount of money based on the customer identification information included in the payment instruction. The adjustment information generation unit 203 may transmit the adjustment information to the adjustment device 22 that is the transmission source of the payment instruction.

### Fourth Modification

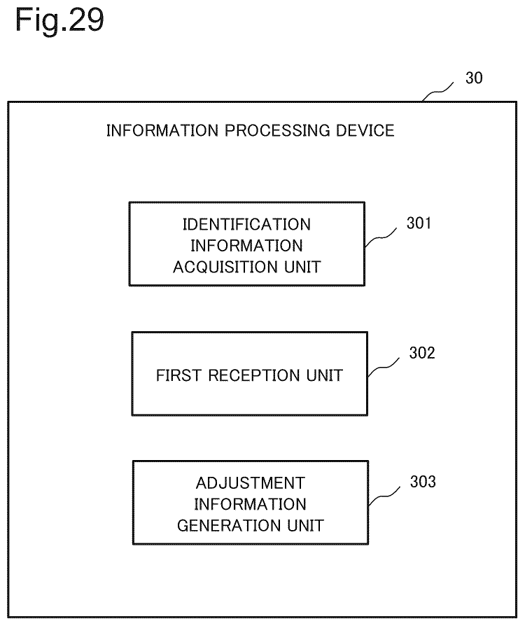

A fourth modification illustrates another basic function example of the information processing device. FIG. 29 is a block diagram illustrating another configuration example of the information processing device. An information processing device 30 includes an identification information acquisition unit 301, a first reception unit 302, and an adjustment information generation unit 303. The information processing device 10 may include one or a plurality of devices.

Identification information acquisition unit 301 acquires the identification information about the product planned to be purchased by the customer by the operation by the customer on the terminal device.

The first reception unit 302 receives, from the terminal device, the first amount of money in the purchase amount of moneys of the products registered by the acquired identification information. When the first reception unit 302 receives each amount of money, this means that it receives a numerical value of the amount of money and identification information indicating the amount of money. The purchase amount of money is the total purchase amount of money as described above. The first amount of money is a payment amount made via the terminal device. The first reception unit 302 may receive the first amount of money received by the terminal device by receiving the first amount of money by the operation by the customer on the terminal device. The first reception unit 302 may receive the first amount of money from the terminal device by receiving the second amount of money that is the amount of payment made by the adjustment device according to the operation by the customer on the terminal device. The total amount of the first amount of money and the second amount of money is the purchase amount of money. Therefore, when the second amount of money is received by the operation by the customer in the terminal device, the first amount of money is an amount obtained by subtracting the second amount of money from the purchase amount of money. In a case where the first amount of money is received by the operation by the customer in the terminal device, the second amount of money is an amount obtained by subtracting the first amount of money from the purchase amount of money. The timing at which the first reception unit 302 receives each amount of money may be after product registration or during product registration, and is not particularly limited.

The adjustment information generation unit 303 generates adjustment information related the second amount of money that is a difference between the purchase amount of money and the first amount of money, the adjustment information being used by the adjustment device for a payment of the second amount of money.

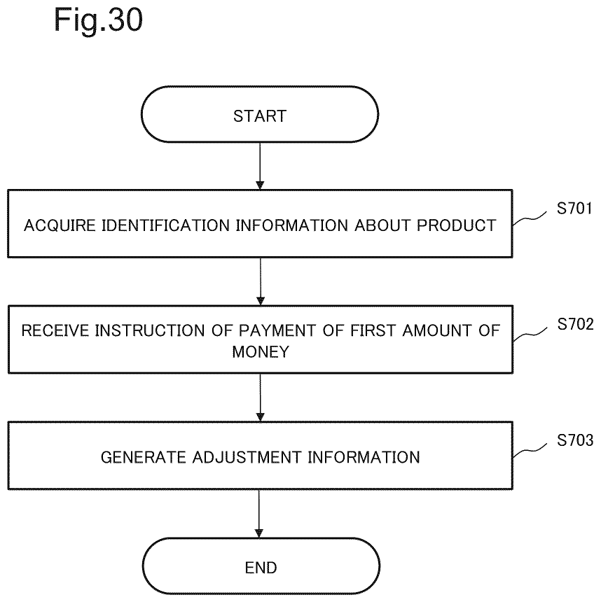

FIG. 30 is a flowchart illustrating another operation example of the information processing device 30. The identification information acquisition unit 301 acquires the product identification information by the operation by the customer on the terminal device (step S701). The first reception unit 302 receives an instruction of a payment of the first amount of money by the operation by the customer on the terminal device (step S702). Next, the adjustment information generation unit 303 generates adjustment information related to the second amount of money that the adjustment device makes a payment of (step S703).

As described above, in the fourth modification, the information processing device 30 acquires the identification information about the product to be registered by the operation by the customer on the terminal device. The information processing device 30 receives, from the terminal device, an instruction of a payment of the first amount of money in the purchase amount of money of the product registered by the acquired identification information. Then, the information processing device 30 generates adjustment information related to the second amount of money that is a difference between the purchase amount of money and the first amount of money, the adjustment information being used by the adjustment device for a payment of the second amount of money. As a result, in a case where the product is registered by the operation by the customer on the terminal device, a plurality of payments can be made, and convenience at the time of shopping can be improved.

### Fifth Modification

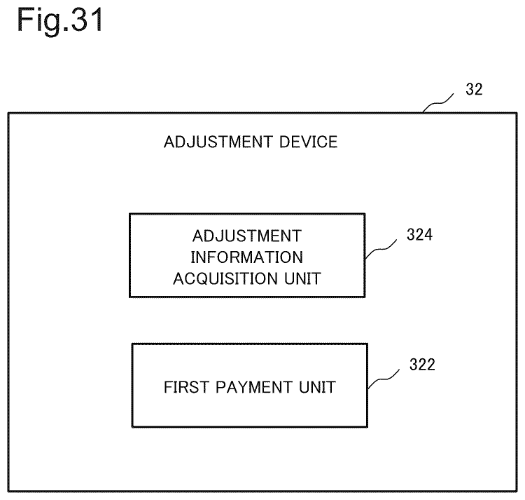

The fifth modification illustrates an example of a basic function of the adjustment device. FIG. 31 is a block diagram illustrating another configuration example of the adjustment device. An adjustment device 32 includes an adjustment information acquisition unit 324 and a first payment unit 322.

The adjustment information acquisition unit 324 acquires adjustment information. The adjustment information relates to a second amount of money that is an amount of a payment made by the adjustment device in the purchase amount of moneys of the products planned to be purchased by the customer. The adjustment information acquisition unit 324 receives adjustment information from the information processing device 30. As a result, the adjustment information acquisition unit 224 may acquire the adjustment information. Alternatively, the adjustment information acquisition unit 324 may acquire the adjustment information via the terminal device. Specifically, for example, the information processing device 30 outputs to the terminal device a code with which the adjustment information can be acquired. Then, the adjustment information acquisition unit 324 acquires the code from the terminal device. The adjustment information acquisition unit 324 acquires the adjustment information from the code.

The first payment unit 322 makes a payment of the second amount of money based on the adjustment information.

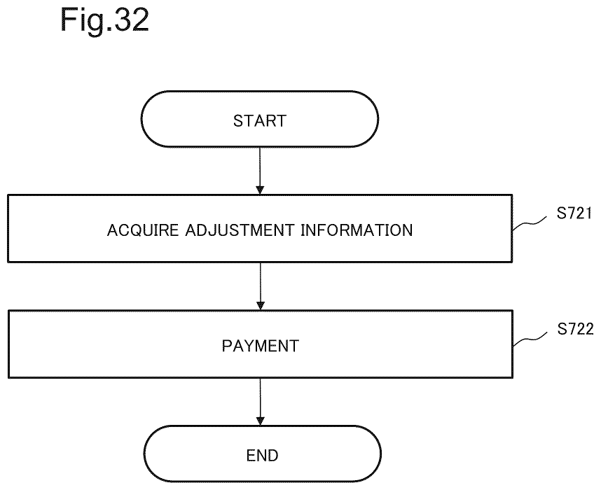

FIG. 32 is a flowchart illustrating another operation example of the adjustment device 32. The adjustment information acquisition unit 324 acquires adjustment information (step S721). Next, the first payment unit 322 makes a payment of the second amount of money (step S722).

As described above, in the fifth modification, the adjustment device 32 acquires adjustment information related to the second amount of money that is the difference between the purchase amount of money and the first amount of money paid through the terminal device, the adjustment information being used by the adjustment device for a payment of the second amount of money, and makes a payment based on the adjustment information. As a result, in a case where the product is registered by the operation by the customer on the terminal device, a plurality of payments can be made, and convenience at the time of shopping can be improved.

The description of each modification is terminated. As described above, the example embodiments and modifications are not limited to the above-described examples, and various modifications can be made. The configuration of each device and the configuration of each device in each example embodiment are not particularly limited. For example, the number of terminal devices, the number of adjustment devices, and the like are not particularly limited.

For example, the information processing device may be achieved by one device, or may be achieved by a plurality of devices different for each piece of information or function. For example, one terminal device may include at least some of the function units of the information processing device described in the second example embodiment. An example of one terminal device includes the terminal device 21 operable by a customer. For example, for each function unit described in the first example embodiment, one terminal device may include the identification information acquisition unit 101 and the first reception unit 102, and the adjustment device may include the second reception unit 121.

For example, the information processing device may include some servers. For example, function units that control input and output of the terminal device such as the identification information acquisition unit 201, the first reception unit 202, and the output control unit 205 may be configured by an application server, a function such as the registration unit 204 may be configured by a point of sale (POS) server, a function such as the second payment unit 206 may be configured by a payment server, and various DBs may be configured by a database server.

In each of the example embodiments, while an example in which the adjustment device includes the first payment unit is described, the adjustment device may function as an interface for receiving an operation by a customer or a store clerk as in the terminal device, and the information processing device may make a payment. That is, the information processing device may include the first payment unit.

Various types of information and DB may be stored in one device (storage means) such as a database server, or may be stored in a distributed manner in a plurality of different devices. Therefore, the various types of information and the DB may be acquired from another device via the communication network NT or the like, or may be stored in the storage means of the information processing device 20 in each example embodiment.

Each device in each example embodiment may be configured to include some function units.

A transmission/reception target may be information itself or an identifier representing information between devices such as the information processing device, the terminal device, and the adjustment device described in each example embodiment and modification.

In each example embodiment and modification, each piece of information may include part of the information described above. Each piece of information and DBs may include information other than the above-described information. Each piece of information or DBs may be divided into a plurality of pieces of information in more detail. As described above, a method of achieving each piece of information and DB is not particularly limited.

Each screen is an example, and is not particularly limited. In each screen, the position, color, and size of each item such as a button, an input field, and a display field are not particularly limited. In each screen, a button, an information display field, an input field, and the like (not illustrated) may be added. The background color of the screen and the like may be changed. For example, although a button is exemplified as an example of receiving various selections, a pull-down list, a checkbox, or the like may be used, and a display example for receiving various selections is not particularly limited.

For example, in each example embodiment, the process of generating information or the like of a screen to be displayed on the display device of the terminal device 21 may be performed by the output control unit 205 of the information processing device 20 or may be performed by the output unit 213 of the terminal device 21.

### (Computer Device)

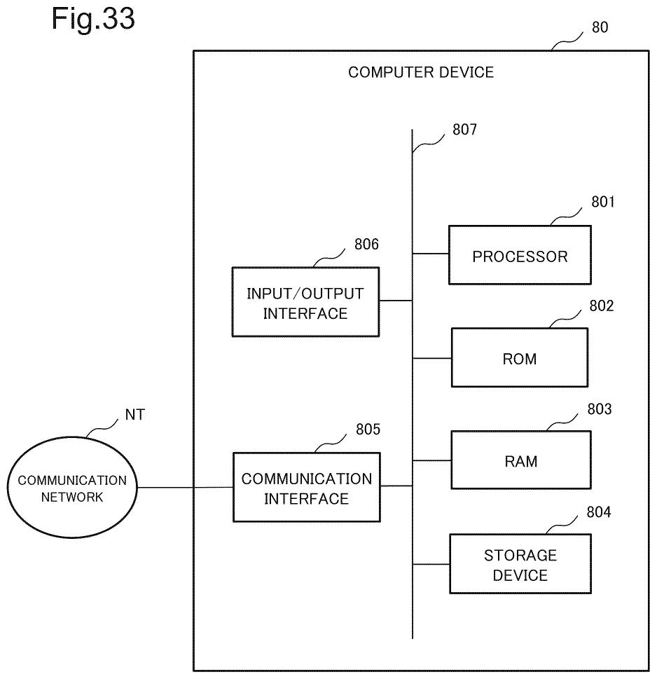

Next, a hardware configuration example in a case where each device such as the information processing device, the terminal device, and the adjustment device described in each example embodiment is implemented by a computer device will be described. FIG. 33 is an explanatory diagram illustrating a hardware configuration example of a computer device. For example, some or all of the devices can be achieved by using an any combination of a computer device 80 and the program as illustrated in FIG. 33, for example.

The computer device 80 includes, for example, a processor 801, a read only memory (ROM) 802, a random access memory (RAM) 803, a storage device 804, a communication interface 805, and an input/output interface 806. The components are connected via a bus 807.

The processor 801 controls the entire computer device 80. Examples of the processor 801 include a central processing unit (CPU), a digital signal processor (DSP), and the like. The number of processors 801 is not particularly limited, and the number of processors 801 is one or more. The computer device 80 includes a ROM 802, a RAM 803, a storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801. The number of each of the ROM 802, the RAM 803, and the storage device 804 is not particularly limited, and the number of each of the ROM 802, the RAM 803, and the storage device 804 is one or more.

The processor 801 loads a program stored in the storage device 804, the ROM 802, or the like. Then, the processor 801 executes each process or each instruction coded in the program. The processor 801 may download various programs via the communication network NT. The processor 801 functions as part or all of the computer device 80. Then, the processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks. As a result, the computer device 80 is connected to an external device or an external computer device 80 via the communication network NT. The communication interface 805 manages an interface between the communication network NT and the inside of the computer device 80. Then, the communication interface 805 controls an input/output of data from an external device or an external computer device.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a speaker that is an audio output device that outputs a voice. Examples of the input/output device include a touch panel display. The input device, the output device, the input/output device, and the like may be built in the computer device 80 or may be externally attached.

The hardware configuration of the computer device 80 is an example. The computer device 80 may have some components illustrated in FIG. 33. The computer device 80 may have components other than those illustrated in FIG. 33. For example, the computer device 80 may include a drive device or the like. Then, the processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer device 80 may include an input device such as a keyboard and a mouse. The computer device 80 may include an output device such as a display. The computer device 80 may include an input device, an output device, and an input/output device.

The computer device 80 may include a reading device capable of reading at least one of the one-dimensional code and the two-dimensional code. The reading device may be an imaging device or a dedicated reading device, and is not particularly limited.

The computer device 80 may include various sensors (not illustrated). The type of the sensor is not particularly limited. Examples of the sensor include an acceleration sensor, a gyro sensor, a magnetic sensor, a global positioning system (GPS), and a sensor.

Examples of the sensor include a fingerprint sensor, light, detection and ranging (LiDAR), a proximity sensor, and an ambient optical sensor.

The description of the hardware configuration of each device ends. There are various modifications in a method of achieving each device. For example, each device may be achieved by an any combination of a computer device and a program different for each component. A plurality of components included in each device may be achieved by any combination of one computer device and a program.

Part or all of each component of each device may be achieved by an application specific circuit. Part or all of each device may be achieved by a general-purpose circuit including a processor such as a field programmable gate array (FPGA). Part or all of each device may be achieved by a combination of an application specific circuit, a general-purpose circuit, or the like. The circuit may be a single integrated circuit. Alternatively, the circuit may be divided into a plurality of integrated circuits. The plurality of integrated circuits may be configured by being connected via a bus or the like.

When part or all of each component of each device is achieved by a plurality of computer devices, circuits, and the like, the plurality of computer devices, circuits, and the like may be disposed in a centralized manner or in a distributed manner.

The payment methods described in the example embodiments are implemented by the payment system. The payment method is achieved by executing a program prepared in advance by a computer device such as a terminal device, an information processing device, or an adjustment device. The program described in each example embodiment is recorded in a computer device-readable recording medium such as an HDD, an SSD, a flexible disk, an optical disk, a flexible disk, a magnetic optical disk, or a USB memory. Then, the program is executed by being read from the recording medium by the computer device. The program may be distributed via the communication network NT.

Functions of respective components of each device in each example embodiment described above may be implemented in hardware as a function of a computer device. Alternatively, each component may be achieved by a computer device or firmware based on program control.

While the present disclosure has been particularly shown and described with reference to each of example embodiments, the present disclosure is not limited to these example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A payment system including
an identification information acquisition means configured to acquire identification information about a product planned to be purchased by a customer by an operation by the customer on a terminal device,
a first reception means configured to receive, from the terminal device, an instruction of a payment of a first amount of money in a purchase amount of money of the product registered based on the acquired identification information, and
a second reception means, of the adjustment device, configured to receive an instruction of a payment of a second amount of money that is a difference between the purchase amount of money and the first amount of money.

### Supplementary Note 2

The payment system according to Supplementary Note 1, further including
an adjustment information generation means configured to generate adjustment information related to the second amount of money, the adjustment information being used by the adjustment device for a payment of the second amount of money.

### Supplementary Note 3

The payment system according to Supplementary Note 1 or 2, wherein
the payment of the second amount of money is payment with a portable cash voucher, and
the adjustment device makes the payment of the second amount of money by an operation by a store clerk.

### Supplementary Note 4

The payment system according to Supplementary Note 1 or 2, wherein
the payment of the second amount of money is a cash payment.

### Supplementary Note 5

The payment system according to any one of Supplementary Notes 1 to 4, wherein
the first reception means receives an instruction of the payment of the first amount of money by receiving an input of the first amount of money by the operation by the customer on the terminal device.

### Supplementary Note 6

The payment system according to any one of Supplementary Notes 1 to 4, wherein
the first reception means receives an instruction of the payment of the first amount of money that is an amount obtained by subtracting the second amount of money from the purchase amount of money by receiving an input of the second amount of money by an operation by the customer on the terminal device.

### Supplementary Note 7

The payment system according to any one of Supplementary Notes 1 to 6, further including
a second payment means configured to make the payment of the first amount of money.

### Ssupplementary Note 8

The payment system according to Supplementary Note 7, wherein
the payment of the first amount of money is at least one of a credit payment, a code payment, and an electronic money payment.

### Supplementary Note 9

The payment system according to Supplementary Note 2, wherein
when the adjustment device makes a payment of a partial amount of the second amount of money,
the adjustment information generation means generates adjustment information related to a remaining amount in the second amount of money, the adjustment information related to a remaining amount that another adjustment device makes a payment of.

### Supplementary Note 10

The payment system according to any one of Supplementary Notes 1 to 9, wherein
a method of the payment of the first amount of money is different from a method of the payment of the second amount of money.

### Supplementary Note 11

An information processing device including
an identification information acquisition means configured to acquire identification information of a product planned to be purchased by a customer by an operation by the customer on a terminal device,
a first reception means configured to receive, from the terminal device, an instruction of a payment of a first amount of money in a purchase amount of money of the product registered based on the acquired identification information, and
an adjustment information generation means configured to generate adjustment information related to a second amount of money that is a difference between the purchase amount of money and the first amount of money, the adjustment information being used by an adjustment device for a payment of the second amount of money.

### Supplementary Note 12

An adjustment device including
an adjustment information acquisition means configured to acquire adjustment information related to a second amount of money that is a difference between a purchase amount of money of a product registered by identification information about the product acquired via a terminal device operable by a customer and a first amount of money paid via the terminal device, and
a first payment means configured to make a payment of the second amount of money.

### Supplementary Note 13

The adjustment device according to Supplementary Note 12, further including
an issuing means configured to issue a receipt, wherein
the first amount of money and the second amount of money are identified and displayed on the receipt.

### Supplementary Note 14

A payment method of a payment system including an information processing device and an adjustment device, the payment method including:
by the information processing device,
acquiring identification information about a product planned to be purchased by a customer by an operation by the customer on a terminal device, and
receiving, from the terminal device, an instruction of a payment of a first amount of money in a purchase amount of money of the product registered based on the acquired identification information; and
by the adjustment device,
receiving an instruction of a payment of a second amount of money that is a difference between the purchase amount of money and the first amount of money.

### Supplementary Note 15

A payment method of an information processing device, the payment method including
acquiring identification information about a product planned to be purchased by a customer by an operation by the customer on a terminal device,
receiving, from the terminal device, an instruction of a payment of a first amount of money in a purchase amount of money of the product registered by the acquired identification information, and
generating adjustment information related to a second amount of money that is a difference between the purchase amount of money and the first amount of money, the adjustment information being used by an adjustment device for a payment of the second amount of money.

### Supplementary Note 16

A payment method of an adjustment device, the payment method including
acquiring adjustment information related to a second amount of money that is a difference between a purchase amount of money of a product registered by identification information about the product acquired via a terminal device operable by a customer and a first amount of money paid via the terminal device, and
making a payment of the second amount of money.

### Supplementary Note 17

A non-transitory recording medium for recording a program of a payment system including an information processing device and an adjustment device, the medium being readable by a computer of the information processing device and by a computer of the adjustment device, the program causing
the computer of the information processing device to execute the steps of
acquiring identification information about a product planned to be purchased by a customer by an operation by the customer on a terminal device, and
receiving, from the terminal device, an instruction of a payment of a first amount of money in a purchase amount of money of the product registered based on the acquired identification information, and
the computer of the adjustment device to execute the step of
receiving an instruction of a payment of a second amount of money that is a difference between the purchase amount of money and the first amount of money.

### Supplementary Note 18

A non-transitory recording medium that records a program, the medium being readable by a computer, the program causing the computer to execute the steps of
acquiring identification information about a product planned to be purchased by a customer by an operation on a terminal device by the customer,
receiving, from the terminal device, an instruction of a payment of a first amount of money in a purchase amount of money of the product registered by the acquired identification information, and
generating adjustment information related to a second amount of money that is a difference between the purchase amount of money and the first amount of money, the adjustment information being used by an adjustment device for a payment of the second amount of money.

### Supplementary Note 19

A non-transitory recording medium that records a program, the medium being readable by a computer, the program causing the computer to execute the steps of
acquiring adjustment information related to a second amount of money that is a difference between a purchase amount of money of a product registered by identification information about the product acquired via a terminal device operable by a customer and a first amount of money paid via the terminal device, and
making a payment of the second amount of money.

### Supplementary Note 20

A program of a payment system including an information processing device and an adjustment device, the program causing
a computer of the information processing device to execute the steps of
acquiring identification information about a product planned to be purchased by a customer by an operation by the customer on a terminal device, and
receiving, from the terminal device, an instruction of a payment of a first amount of money in a purchase amount of money of the product registered based on the acquired identification information, and
a computer of the adjustment device to execute the step of
receiving an instruction of a payment of a second amount of money that is a difference between the purchase amount of money and the first amount of money.

### Supplementary Note 21

A program for causing a computer to execute the steps of acquiring identification information about a product planned to be purchased by a customer by an operation on a terminal device by the customer,
receiving, from the terminal device, an instruction of a payment of a first amount of money in a purchase amount of money of the product registered by the acquired identification information, and
generating adjustment information related to a second amount of money that is a difference between the purchase amount of money and the first amount of money, the adjustment information being used by an adjustment device for a payment of the second amount of money.

### Supplementary Note 22

A program for causing a computer to execute the steps of acquiring adjustment information related to a second amount of money that is a difference between a purchase amount of money of a product registered by identification information about a product acquired via a terminal device operable by a customer and a first amount of money paid via the terminal device, and
making a payment for the second amount of money.

### REFERENCE SIGNS LIST

1, 2 payment system
20, 30 information processing device
21 terminal device
22, 32 adjustment device
80 computer device
101, 201, 301 identification information acquisition unit
102, 202, 302 first reception unit
203, 303 adjustment information generation unit
204 registration unit
205 output control unit
206 second payment unit
207 sales accounting unit
208 determination unit
209 invalidating unit
211 identification information reading unit
212 amount reception unit
213 output unit
214 payment information reception unit
215 instruction reception unit
121, 221 second reception unit
222, 322 first payment unit
223 receipt issuing unit
224, 324 adjustment information acquisition unit
801 processor
802 ROM
803 RAM
804 storage device
805 communication interface
806 input/output interface
807 bus
d001 reading screen
d002 list screen
d003 screen
d004 screen
d005 screen
d006 screen
d007 screen
d008 screen
d010 screen
d011 screen
d012 list screen
d013 screen
2001 product DB
2002 list DB
2003 sales DB
NT communication network

What is claimed is:

1. A payment system comprising:
an information processing device including
a first memory storing first instructions; and
at least one first processor configured to execute the first instructions to:
acquire identification information about a product planned to be purchased by a customer by an operation by the customer on a terminal device, and
receive, from the terminal device, an instruction of a payment of a first amount of money in a purchase amount of money of the product registered based on the acquired identification information; and
an adjustment device including
a second memory storing second instructions; and
at least one second processor configured to execute the second instructions to:
receive an instruction of a payment of a second amount of money that is a difference between the purchase amount of money and the first amount of money.

2. The payment system according to claim 1, wherein the at least one first processor is further configured to execute the first instructions to:
to generate adjustment information related to the second amount of money, the adjustment information being used by the adjustment device for a payment of the second amount of money.

3. The payment system according to claim 1, wherein
the payment of the second amount of money is payment with a portable cash voucher, wherein the at least one second processor is further configured to execute the second instructions to:
make the payment of the second amount of money by an operation by a store clerk.

4. The payment system according to claim 1, wherein
the payment of the second amount of money is a cash payment.

5. The payment system according to claim 1, wherein the at least one first processor is further configured to execute the first instructions to:
receive an instruction of the payment of the first amount of money by receiving an input of the first amount of money by the operation by the customer on the terminal device.

6. The payment system according to claim 1, wherein the at least one first processor is further configured to execute the first instructions to:
an instruction of the payment of the first amount of money that is an amount obtained by subtracting the second amount of money from the purchase amount of money by receiving an input of the second amount of money by an operation by the customer on the terminal device.

7. The payment system according to claim 1, wherein the at least one first processor is further configured to execute the first instructions to:
to make the payment of the first amount of money.

8. The payment system according to claim 7, wherein
the payment of the first amount of money is at least one of a credit payment, a code payment, and an electronic money payment.

9. The payment system according to claim 2, wherein the at least one first processor is further configured to execute the first instructions to:
when the adjustment device makes a payment of a partial amount of the second amount of money,
generate adjustment information related to a remaining amount in the second amount of money, the adjustment information related to a remaining amount that another adjustment device makes a payment of.

10. A payment method of a payment system including an information processing device and an adjustment device, the payment method comprising:
by the information processing device,
acquiring identification information about a product planned to be purchased by a customer by an operation by the customer on a terminal device, and
receiving, from the terminal device, an instruction of a payment of a first amount of money in a purchase amount of money of the product registered based on the acquired identification information; and
by the adjustment device,
receiving an instruction of a payment of a second amount of money that is a difference between the purchase amount of money and the first amount of money.

11. A non-transitory recording medium for recording a program of a payment system including an information processing device and an adjustment device, the medium being readable by a computer of the information processing device and by a computer of the adjustment device, the program causing
the computer of the information processing device to execute the steps of:
acquiring identification information about a product planned to be purchased by a customer by an operation by the customer on a terminal device; and
receiving, from the terminal device, an instruction of a payment of a first amount of money in a purchase amount of money of the product registered based on the acquired identification information, and
the computer of the adjustment device to execute the step of
receiving an instruction of a payment of a second amount of money that is a difference between the purchase amount of money and the first amount of money.
